(19) United States
(12) Patent Application Publication
(10) Pub. No.: US 2025/0056647 A1
(43) Pub. Date: Feb. 13, 2025

(54) IAB NODE DEVICE, IAB-DONOR DEVICE AND TRANSPORT ADDRESS DETERMINATION METHOD

(71) Applicant: FUJITSU LIMITED, Kawasaki-shi (JP)

(72) Inventor: Yang LU, Beijing (CN)

(73) Assignee: FUJITSU LIMITED, Kawasaki-shi (JP)

(21) Appl. No.: 18/910,068

(22) Filed: Oct. 9, 2024

Related U.S. Application Data
(63) Continuation of application No. PCT/CN2022/086455, filed on Apr. 12, 2022.

(51) Int. Cl. H04W 76/20; H04W 36/08; H04W 88/08

(52) U.S. Cl. CPC H04W 76/20; H04W 36/08; H04W 88/08

(57) ABSTRACT

An integrated access and backhaul IAB node includes: a receiver configured to receive a first RRC (Radio Resource Control) reconfiguration message, the first RRC reconfiguration message including IP address information for the IAB node of an F1-terminating topology domain which includes a TNL (transport network layer) address anchored at a donor-DU under an F1-terminating donor-CU for the IAB node, or IP address information for the IAB node of a non-F1-terminating topology domain which includes a TNL address anchored at a donor-DU under a non-F1-terminating donor-CU for the IAB node.

### CROSS-REFERENCE TO RELATED APPLICATION

This application is a continuation application of International Application PCT/CN2022/086455 filed on Apr. 12, 2022, and designated the U.S., the entire contents of which are incorporated herein by reference.

### TECHNICAL FIELD

This disclosure relates to the field of communication technologies.

### BACKGROUND

Seamless cellular network deployment in the future needs very flexible and ultra-dense new radio (NR) cell deployment. The ultra-dense network is one of goals of 5G, and deployment of an NR network with no wired backhaul is very important for the realization of 5G ultra-dense network. As coverage of a cell is reduced by a 5G millimeter wave, it is further needed that a wireless self-backhauling system is of multi-hop to meet deployment requirements. High bandwidth, large-scale MIMO and beam system of 5G make it easier for 5G to develop the wireless self-backhauling system of ultra-dense NR cells than LTE. In order to develop this multi-hop system with wireless self-backhauling, 3GPP began research and standardization of an IAB (integrated access and backhaul) project in Rel-16.

FIG. 1 is a schematic diagram of an IAB system. As shown in FIG. 1, in the IAB system, a relay node supports both access and backhaul functions. A wireless transmission link of the relay node multiplexes an access link and backhaul link in the time domain, frequency domain or spatial domain. The access link and backhaul link may use identical or different frequency bands.

In an IAB network architecture, the relay node refers to an IAB node, which supports both access and backhaul functions. A prior hop of access node at the network side is referred to as an IAB-donor, which supports a gNB function and supports IAB node access. All UE data may be backhauled to the IAB-donor in one or more hops via the IAB node.

Functions of the IAB node are divided into two parts, one is a gNB-DU function, referred to as an IAB-DU (distribution unit), and the other is a UE function, referred to as an IAB-MT (mobile terminal). The IAB-DU realizes device function at a network side, is connected to a downstream child IAB node, provides NR air access to the UE and the downstream child IAB node, and establishes F1 connection with the IAB-donor-CU. The IAB-MT realizes some functions of a terminal equipment and is connected to an upstream parent IAB node or IAB-donor-DU. The IAB-MT includes physical layer, layer 2, RRC (Radio Resource Control) and NAS (Non-Access Stratum) layer functions, and is further indirectly connected to the IAB-donor-CU and a core network (CN).

In the IAB system, the IAB node may access to the network in a standalone (SA) mode or E-UTRA-NR Dual Connectivity (EN-DC) mode. FIG. 2 is a schematic diagram of an IAB architecture of the SA mode. FIG. 3 is a schematic diagram of an IAB architecture of the EN-DC mode.

FIG. 4 is a schematic diagram of an IAB node, a parent IAB node and a child IAB node. As shown in FIG. 4, an IAB-DU of the IAB node is taken as IAB-MT connection between a network side and the child IAB node, and an IAB-MT of the IAB node is taken as a terminal side and connected to the IAB-DU of the parent node.

FIG. 5 is a schematic diagram of an F1 user interface (F1-U) protocol stack between the IAB-DU and IAB-donor-CU. FIG. 6 is a schematic diagram of an F1 control plane (F1-C) protocol stack between the IAB-DU and IAB-donor-CU. As shown in FIG. 5 and FIG. 6, the F1-U and F1-C are built on a transport (IP) layer between the IAB-DU and IAB-donor-CU. Two hops of wireless backhaul and one hop of wired backhaul are performed in FIG. 5 and FIG. 6.

On the backhaul link, the transport (IP) layer is carried on a backhaul adaptive protocol (BAP) sublayer. A BAP entity in the IAB node executes a routing function of the IAB system, and the IAB-donor-CU provides a routing table. BAP PDUs (protocol data unit) are transmitted in an RLC (radio link control) channel of the backhaul link, multiple RLC channels of the backhaul link may be configured by the IAB-donor to carry traffics of different priorities and QoS, and the BAP entity maps the BAP PDUs to different backhaul RLC channels.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY OF THE DISCLOSURE

It was found by the inventors that if all or a part of traffics of an IAB node needs to be migrated from an F1-terminating topology domain or configured to a non-F1-terminating topology domain, routing IDs of all or a part of the traffics of the IAB node belongs to the non-F1-terminating topology domain, that is, the IAB node needs to transmit both traffics with routing IDs belonging to the F1-terminating topology domain and traffics with routing IDs belonging to the non-F1-terminating topology domain. However, there is currently no corresponding solution for how an IAB node can separately transmit traffics with routing IDs belonging to the F1-terminating-topology domain and traffics with routing IDs belonging to the non-F1-terminating topology domain.

In order to solve at least one of the above problems, embodiments of this disclosure provide an IAB node device, an IAB-donor device and a transport address determination method.

According to one aspect of the embodiments of this disclosure, there is provided an integrated access and backhaul IAB node device, the device including:
a first receiving portion configured to receive a first RRC reconfiguration message, the first RRC reconfiguration message including at least one IP address configuration for the IAB node,
the at least one IP address configuration containing IP address information of an F1-terminating topology domain, or containing IP address information of a non-F1-terminating topology domain.

According to another aspect of the embodiments of this disclosure, there is provided an integrated access and backhaul IAB-donor device, applicable to a first IAB-donor, the device including:
a first transmitting portion configured to transmit a first RRC reconfiguration message, the first RRC reconfiguration message including at least one IP address configuration for an IAB node, or transmit at least one IP address configuration of the IAB node,
the at least one IP address configuration containing IP address information of an F1-terminating topology domain, or containing IP address information of a non-F1-terminating topology domain,
wherein F1 connection of the IAB node is terminated at the first IAB-donor, and there exists RRC connection between the IAB node and a second IAB-donor.

According to a further aspect of the embodiments of this disclosure, there is provided an integrated access and backhaul IAB-donor device, applicable to a second IAB-donor, the device including:
a second transmitting portion configured to transmit a first RRC reconfiguration message, the first RRC reconfiguration message including at least one IP address configuration for an IAB node, or transmit at least one IP address configuration for an IAB node,
the at least one IP address configuration containing IP address information of an F1-terminating topology domain, or containing IP address information of a non-F1-terminating topology domain,
wherein F1 connection of the IAB node is terminated at a first IAB-donor, and there exists RRC connection between the IAB node and the second IAB-donor.

An advantage of the embodiments of this disclosure exists in that the IP address of the non-F1-terminating topology domain or the IP address of the F1-terminating topology domain may be configured to the IAB node via the first RRC reconfiguration message. Hence, for a routing ID of the non-F1-terminating topology domain, the IAB node may use the IP address of the non-F1-terminating topology domain, and for a routing ID of the F1-terminating topology domain, the IAB node may use the IP address of the F1-terminating topology domain.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/comprising/include/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

The drawings are included to provide further understanding of this disclosure, which constitute a part of the specification and illustrate the preferred embodiments of this disclosure, and are used for setting forth the principles of this disclosure together with the description. It is obvious that the accompanying drawings in the following description are some embodiments of this disclosure, and for those of ordinary skills in the art, other accompanying drawings may be obtained according to these accompanying drawings without making an inventive effort. In the drawings:

FIG. 1 is schematic diagram of an IAB system;

FIG. 2 is a schematic diagram of an IAB architecture in an SA mode;

FIG. 3 is a schematic diagram of an IAB architecture in an EN-DC mode;

FIG. 4 is a schematic diagram of a parent IAB node and a child IAB node;

FIG. 5 is a schematic diagram of an F1-U protocol stack of the IAB system;

FIG. 6 is a schematic diagram of an F1-C protocol stack of the IAB system;

FIG. 7 is a schematic diagram of IAB system routing;

FIG. 8 is a schematic diagram of network topology adaptation;

FIG. 9 is a schematic diagram of an IAB device of embodiments of this disclosure;

FIG. 10 is a schematic diagram of a transport address determination method of the embodiments of this disclosure;

FIG. 11 is a schematic diagram of a handover scenario;

FIG. 12 is a schematic diagram of dual-connectivity scenario 1;

FIG. 13 is a schematic diagram of dual-connectivity scenario 2;

FIG. 14 is a schematic diagram of a transport address determination method of embodiments of this disclosure;

FIG. 15 is a schematic diagram of a transport address determination method of embodiments of this disclosure;

FIG. 16 is a schematic diagram of an IAB node device of embodiments of this disclosure;

FIG. 17 is a schematic diagram of an IAB-donor device of embodiments of this disclosure; and

FIG. 18 is a schematic diagram of an IAB-donor device of embodiments of this disclosure.

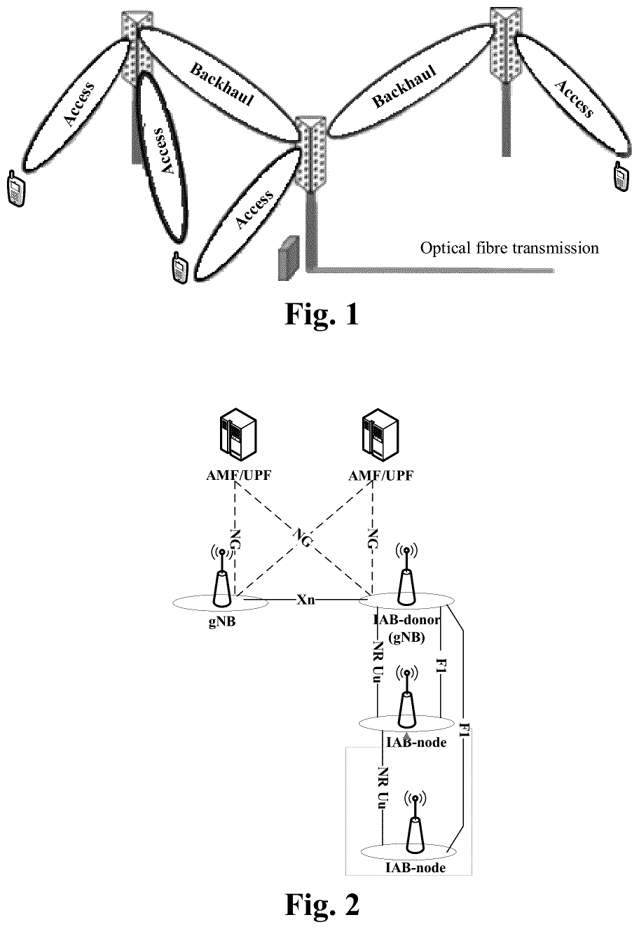

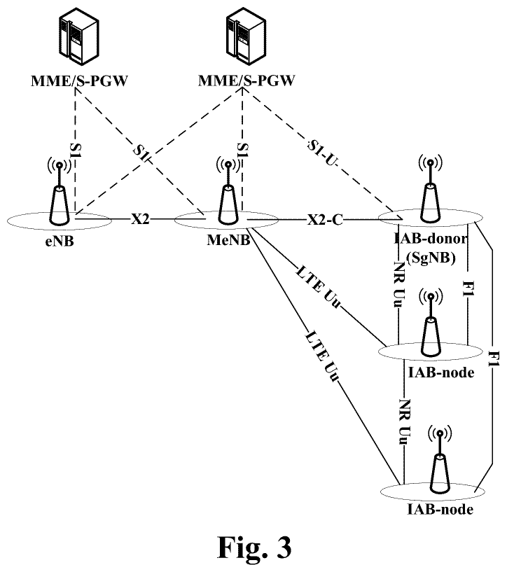

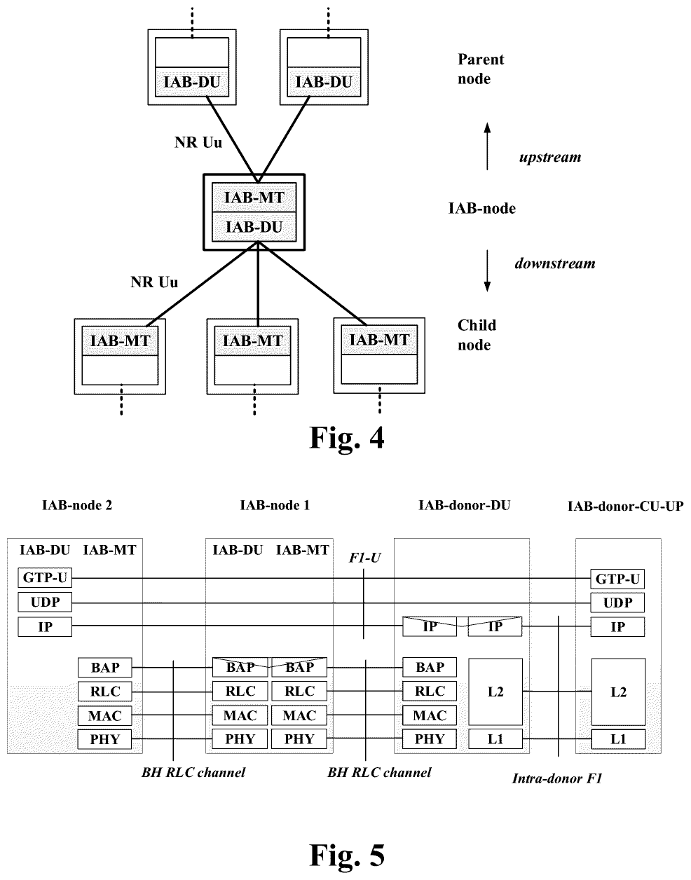

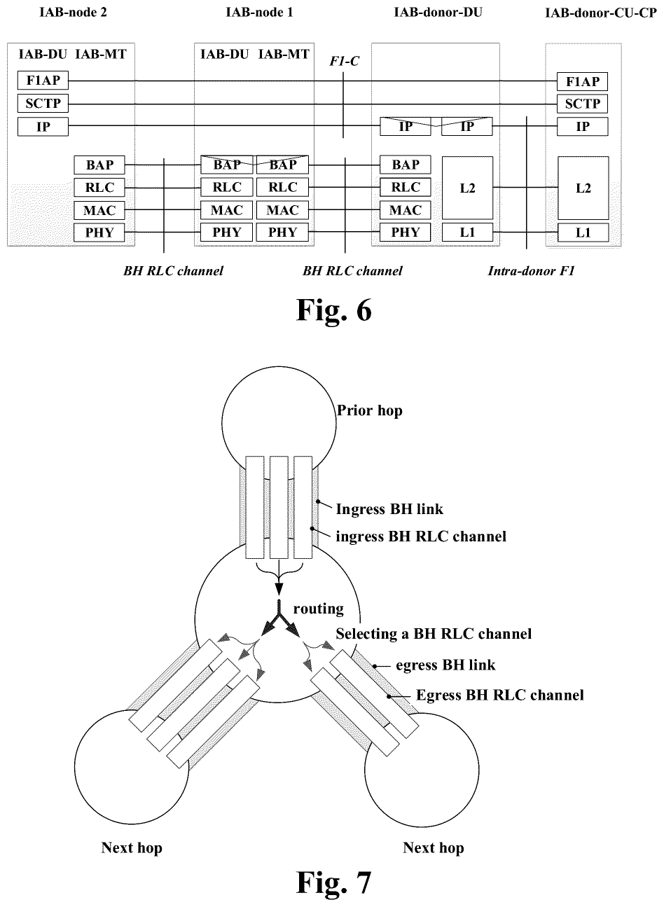

### DETAILED DESCRIPTION OF THE DISCLOSURE

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and 6G in the future, etc., and/or other communication protocols that are currently known or will be developed in the future.

In the embodiments of this disclosure, the term “network device”, for example, refers to a device in a communication system that accesses a user equipment to the communication network and provides traffics for the user equipment. The network device may include but not limited to the following equipment: a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” refers to, for example, an equipment accessing to a communication network and receiving network traffics via a network device, and may also be referred to as “a terminal equipment (TE)”. The terminal equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

Signaling radio bearers (SRBs) include SRB0, SRB1, SRB2, and SRB3, etc., wherein SRB0, SRB1 and SRB2 lead to an MN, and SRB3 leads to an SN. The signaling radio bearers are radio bearers used to transmit RRC and NAS messages. SRB0 transmits an RRC message using a common control channel (CCCH) logical channel. SRB1 transmits an RRC message (which may include a piggybacked NAS message) and an NAS message before SRB2 is set up, and uses a dedicated control channel (DCCH) logical channel. SRB2 transmits an NAS message and an RRC message containing a log measurement message, and uses a DCCH logical channel. SRB2 has a lower priority than SRB1 and may be configured by the network after an access stratum (AS) is securely activated. And SRB3 is used for a specific RRC message when a UE is in (NG) EN-DC or NR-DC, and uses a DCCH logical channel.

A routing function of an IAB system is carried out by a BAP layer, and each IAB node saves BH routing configuration and BH RLC channel mapping configuration. A BAP entity performs routing according to the routing configuration, the RLC channel mapping configuration and a routing ID in a BAP layer packet header. The routing ID contains a destination BAP address and a path ID.

The routing configuration includes a mapping relationship between the routing ID and a BAP address of a next-hop node. The RLC channel mapping configuration includes a BAP address of a prior-hop node, and a mapping relationship between an ingress link RLC channel ID, the BAP address of the next-hop node and an egress link RLC channel ID.

FIG. 7 is a schematic diagram of IAB system routing. As shown in FIG. 7, for each packet, the BAP address of the next-hop node may be looked up from the routing configuration via the routing ID of the packet header. The BAP address of the prior-hop node and the ingress link RLC channel ID are already known. Hence, after the BAP address of the next-hop node is determined, the egress link RLC channel ID may be looked up via the RLC channel mapping configuration according to the BAP address of the prior-hop node+the ingress link RLC channel ID+the BAP address of the next-hop node.

An IAB-donor DU saves the routing configuration (BH routing configuration) and downlink traffic to BH RLC channel mapping configuration. The IAB-donor-DU performs routing according to the routing configuration, the RLC channel mapping configuration and the routing ID in the BAP layer packet header. The routing configuration includes the mapping relationship between the routing ID and a next-hop node address. The downlink RLC channel mapping configuration includes a target IP address, a DSCP (differentiated traffics code point) and a mapping relationship between the next-hop node address and the egress link RLC channel ID.

For each downlink packet arriving at the IAB-donor-DU, the IAB-donor-DU may look up the next-hop node address from the routing configuration according to the routing ID in the packet header. Hence, after the next-hop node address is determined, the egress link RLC channel ID may be looked up from the downlink RLC channel mapping configuration according to the IP address and DSCP of the packet.

An access IAB node saves uplink backhaul information (BH information), including a routing ID used by the traffics, an uplink backhaul RLC channel ID and the next-hop node address. The access IAB node configures the routing ID in the BAP layer packet header of uplink traffics according to the uplink BH information, and selects BH RLC channels of uplink traffic transmission and the next-hop node.

The IAB system routing and BH RLC channel mapping are illustrated above, and update of network topology of the IAB system shall be described below. A topology adaptation process when an IAB node moves under the same donor-CU has been standardized in Rel-16 NR.

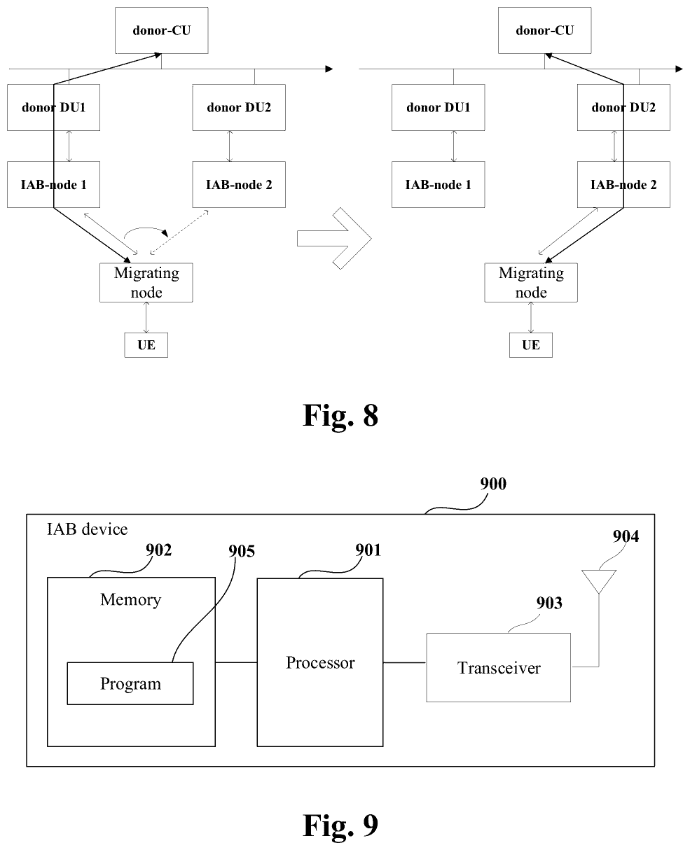

FIG. 8 is a schematic diagram of intra-CU topology adaptation. When the IAB node changes its parent node (from IAB node 1 to IAB node 2), the donor-CU configures path migration related configuration for the IAB node via an RRC reconfiguration message, so that the IAB node performs migration of an F1 transport path.

The path migration related configuration includes updating default BH RLC channels of uplink F1-C, F1-U and non-F1 data, updating a default BAP routing ID and updating an IP address routed to the donor-DU. When the IAB node accesses to a new parent node, the above path migration related configuration is applied. For a child node of the IAB node, path migration related configuration is performed in the same manner.

3GPP Rel-17 supports a process of network topology update and backhaul (BH) radio link failure (RLF) recovery when an IAB node moves under different donor-CUs. The IAB node may be handed over or may reestablish connection from a parent node served by a source donor-CU (also referred to as an F1-terminating CU or a first donor-CU) to a parent node served by a target donor-CU (also referred to as a non-F1-terminating CU or a second donor-CU), and all traffics of the IAB node (and traffics of its child node) need to be migrated to topology of the non-F1-terminating CU. Rel-17 also supports a topology redundancy process when the IAB node establishes dual connectivity with the non-F1-terminating CU, and transport paths of a part of traffics of the IAB node may be migrated to the topology of the non-F1-terminating CU.

After the IAB node is handed over/RLF recovered from donor-CU 1 (F1-terminating CU) to donor-CU 2 (non-F1-terminating CU) or RRC connection between it and donor-CU 2 is added, only RRC of an IAB-MT is connected to donor-CU 2, and an F1 interface is still terminated at donor-CU 1. At this time, the IAB node may also be referred to as a boundary node. RRC connection and an F1 interface of a child node served by it still belong to donor-CU1. Hence, a routing ID, a BH RLC channel and next-hop BAP address of traffics of the child node still belong to the F1-terminating topology domain.

Routing IDs of all or a part of traffics of the boundary node belongs to the non-F1-terminating topology domain, that is, the boundary node needs to both transmit traffics with routing IDs belonging to the F1-terminating topology domain and traffics with routing IDs belonging to the non-F1-terminating topology domain. However, there is currently no corresponding solution for how a boundary node can respectively transmit traffics with routing IDs belonging to an F1-terminating topology domain and traffics with routing IDs belonging to a non-F1-terminating topology domain.

In the embodiments of this disclosure, an IAB node device includes a migrating node or its child node, unless otherwise specified. In addition, “resources of traffics that have been established in a topology domain of a donor-CU for serving for an IAB node” may also be referred to as “migrating traffics of the IAB node to the topology domain of the donor-CU”, etc. However, this disclosure is not limited to these expressions. The embodiments of this disclosure shall be further described below.

### Embodiments of a First Aspect

The embodiments of this disclosure provide a transport address determination method, which shall be described from an IAB node device.

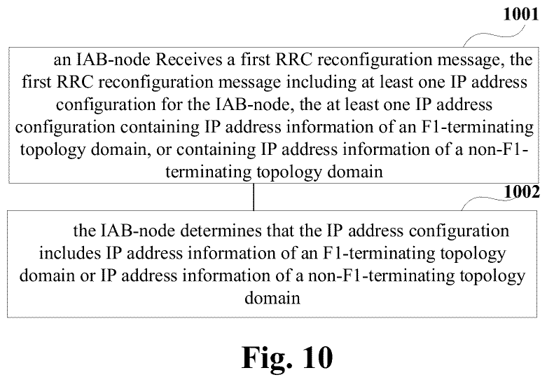

FIG. 10 is a schematic diagram of a transport address determination method of the embodiments of this disclosure. As shown in FIG. 10, the method includes:
1001: an IAB node receives a first RRC reconfiguration message, the first RRC reconfiguration message including at least one IP address configuration for the IAB node, the at least one IP address configuration containing IP address information of an F1-terminating topology domain, or containing IP address information of a non-F1-terminating topology domain.

It should be noted that FIG. 10 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 10.

For the routing ID of the non-F1-terminating topology domain, the boundary node needs to use the IP address of the non-F1-terminating topology domain, i.e. an IP address anchored at the IP address of the donor-DU of the non-F1-terminating topology domain; and for the routing ID of the F1-terminating topology domain, the IP address of the F1-terminating topology domain needs to be used, i.e. an IP address of the donor-DU anchored at the F1-terminating topology domain. It can be seen from the above embodiments that the IP address of the non-F1-terminating topology domain or the IP address of the F1-terminating topology domain may be configured to the IAB node via the first RRC reconfiguration message. Hence, the boundary node may be able to respectively transmit traffics with routing IDs belonging to the F1-terminating topology domain and traffics with routing IDs belonging to the non-F1-terminating topology domain.

In some embodiments, the IAB node includes a migrating node or its child node. For example, when the IAB node is a migrating node (also referred to as a boundary node), F1 connection of the IAB node is terminated at a first IAB-donor (e.g. a first IAB-donor-CU), and the IAB node has RRC connection with a second IAB-donor (e.g. a second IAB-donor-CU). For example, an IAB-MT of the IAB node maintains RRC connection with the second IAB-donor. In the following description, the first IAB-donor is also referred to as an F1-terminating donor (such as an F1-terminating donor-CU), and the second IAB-donor is also referred to as a non-F1-terminating donor (such as a non-F1-terminating donor-CU), wherein the F1-terminating donor refers to an IAB-donor that terminates an F1 interface of the boundary IAB node and its child IAB node, that is, the first IAB-donor. The non-F1-terminating donor refers to a donor has a function of donor that does not terminate the F1 interface of the boundary IAB node and its child IAB node, such as a second IAB-donor.

In some embodiments, the IP address refers to an IP address anchored at the donor-DU and configured for the IAB node, and at least one IP address configuration in the first RRC reconfiguration message may be IP address configuration of at least two donor-DUs, and may also be at least one IP address configuration of one donor-DU. Each IP address configuration may include an IP address index and a corresponding IP address, and the embodiments of this disclosure is not limited thereto.

In the embodiments of this disclosure, “an IP address anchored at IAB-donor-DU” may be understood as “an IP address allocated by the donor-DU” or “TNL (transport network layer) address(es) that is (are) routable via the IAB-donor-DU”, and the above terms are interchangeable. However, this disclosure is not limited thereto, for example, the IP address of the donor-DU of the non-F1-terminating topology domain configured for the IAB node refers to a transport network layer (TNL) address configured for the IAB node that is routable via the donor-DU of the non-F1-terminating topology domain.

In some embodiments, the method may further include:
1002: the IAB node determines that the IP address configuration includes IP address information of an F1-terminating topology domain or IP address information of a non-F1-terminating topology domain.

In some embodiments, whether the configured IP address belongs to the non-F1-terminating topology domain may be implicitly indicated. In 1002, the IAB node may determine that the IP address configuration includes the IP address information of the F1-terminating topology domain or the IP address information of the non-F1-terminating topology domain according to a donor providing the IP address information. For example, when the donor providing the IP address information is an F1-terminating donor, it is determined that the IP address configuration includes the IP address information of the F1-terminating topology domain, and when the donor providing the IP address information is a non-F1-terminating donor, it is determined that the IP address configuration includes the IP address information of the non-F1-terminating topology domain.

In some embodiments, whether the configured IP address belongs to the non-F1-terminating topology domain may be explicitly indicated (such as according to the first indication information). In 1002, the IAB node may determine according to the first indication information that the IP address configuration includes the IP address information of the F1-terminating topology domain or the IP address information of the non-F1-terminating topology domain. For example, the first indication information is used to indicate that the IP address configuration includes the IP address information of the non-F1-terminating topology domain. When the IAB node receives the first indication information, it determines that the IP address configuration includes the IP address information of the non-F1-terminating topology domain. When the IAB node does not receive the first indication information, it determines that the IP address configuration includes the IP address information of the F1-terminating topology domain; however, the embodiments of this disclosure is not limited thereto. A mode of carrying the first indication information and specific examples thereof shall be described later. As can be seen from the above embodiments that by implicit or explicit indication, the IAB node may distinguish whether the configured IP address belongs to the non-F1-terminating topology domain or the F1-terminating topology domain.

Implicit and explicit indications in different scenarios shall be described below respectively.

### (I) For a Handover Scenario

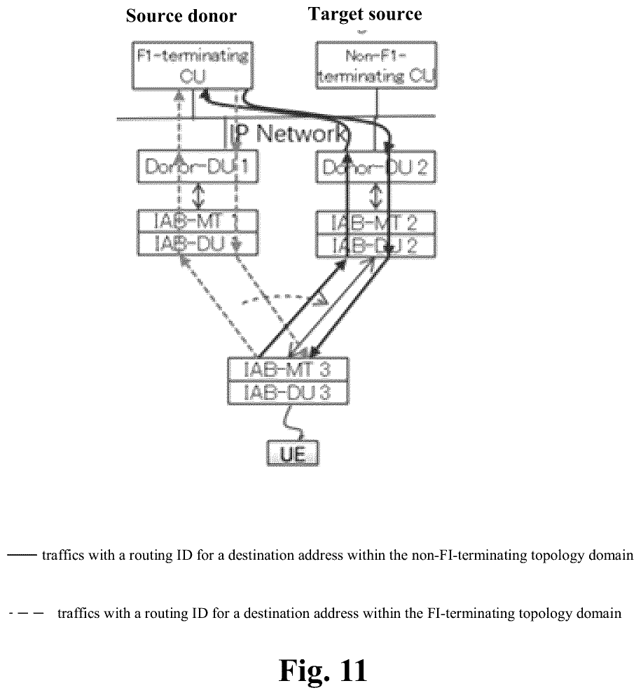

In some embodiments, FIG. 11 is a schematic diagram of a handover scenario. As shown in FIG. 11, in the handover scenario, all traffics of the boundary node are migrated to the non-F1-terminating topology domain. The F1-terminating donor is a source donor of handover of the IAB node, and the non-F1-terminating donor is a target donor of handover of the IAB node. The IP address of the non-F1-terminating topology domain may be configured in the handover process, or the IP address of the non-F1-terminating topology domain may be configured after the handover is completed. In the handover process, the first RRC reconfiguration message is a handover command RRC message generated by the second IAB-donor and forwarded by the first IAB-donor. After the handover process, the first RRC reconfiguration message is an RRC message directly transmitted by the second IAB-donor to the IAB node. The first RRC reconfiguration message includes at least one IP address configuration for the IAB node, the at least one IP address configuration including the IP address information of the non-F1-terminating topology domain, the IP address of the non-F1-terminating topology domain referring to an IP address anchored at donor-DU2. The at least one IP address configuration may be at least one IP address configuration carried by a handover command RRC message, such as RRC reconfiguration information of a reconfiguration WithSync information field in master cell group information therein. The IAB node may determine that at least one IP address configuration configured by the handover command RRC message contains the IP address information of the non-F1-terminating topology domain, or the IAB node may determine that at least one IP address configuration in an RRC message transmitted by the target donor contains the IP address information of the non-F1-terminating topology domain.

### (i) Implicit Indication

For example, during the handover process, as the handover command RRC message is generated by the target donor (i.e. the donor providing the IP address information is the target donor), and the target donor is a non-F1-terminating node, after receiving the handover command RRC message, the IAB node may determine that at least one IP address configuration carried by the handover command RRC message is the IP address information of the non-F1-terminating topology domain.

For example, after the handover is completed, the target donor may directly transmit an RRC message to the IAB node. Upon receiving the RRC message, the IAB node may determine that at least one IP address configuration carried by the RRC message is the IP address information of the non-F1-terminating topology domain.

### (ii) Explicit Indication

For example, during the handover process, when the target donor generates the handover command RRC message, it may introduce a new information element thereto, i.e. first indication information non-F1-terminating. Therefore, after the IAB node receives the handover command RRC message, that is, when the handover command RRC message includes the first indication information, the IAB node determines that at least one IP address configuration carried by the handover command RRC message is the IP address information of the non-F1-terminating topology domain.

For example, after the handover is completed, the target donor may directly transmit an RRC message to the IAB node, and a new information element may be introduced thereto, i.e. first indication information non-F1-terminating-indication. After the IAB node receives the RRC message, that is, when the handover command RRC message includes the first indication information, the IAB node may determine that at least one IP address configuration carried by the RRC message is the IP address information of the non-F1-terminating topology domain.

In some embodiments, the first indication information may be included in a newly-added information element of the RRC reconfiguration message, or may be included in an IP address configuration list information element of the RRC reconfiguration message, or may be included in an IP address configuration information element of the RRC reconfiguration message, or may be included in an IP address index information element of the RRC reconfiguration message, which shall be illustrated below respectively.
1) A new information element, non-F1-terminating-indication, is added into the first RRC reconfiguration message, which is used to indicate that at least one IP address configuration carried by the RRC message is the IP address information of the non-F1-terminating topology domain, or is used to indicate that the at least one IP address configuration is generated by a non-F1-terminating donor.

The first RRC reconfiguration message may be expressed as follows by using an ASN.1 data format:

| | |
|---|---|
| RRCReconfiguration-v1610-IEs ::= | SEQUENCE { |
| otherConfig-v1610 | OtherConfig-v1610 |

OPTIONAL, -- Need M

| | |
|---|---|
| bap-Config-r16 | SetupRelease { BAP-Config-r16 } |

OPTIONAL, -- Need M

| | |
|---|---|
| iab-IP-AddressConfigurationList-r16 | IAB-IP-AddressConfigurationList-r16 |

OPTIONAL, -- Need M

| | |
|---|---|
| conditionalReconfiguration-r16 | ConditionalReconfiguration-r16 |

OPTIONAL, -- Need M

| | |
|---|---|
| daps-SourceRelease-r16 | ENUMERATED{true} |

OPTIONAL, -- Need N

| | |
|---|---|
| t316-r16 | SetupRelease {T316-r16} |

OPTIONAL, -- Need M

| | |
|---|---|
| needForGapsConfigNR-r16 | SetupRelease {NeedForGapsConfigNR- |
| r16} | OPTIONAL, -- Need M |
| onDemandSIB-Request-r16 | SetupRelease { OnDemandSIB-Request- |
| r16 } | OPTIONAL, -- Need M |
| dedicatedPosSysInfoDelivery-r16 | OCTET STRING (CONTAINING |
| PosSystemInformation-r16-IEs) | OPTIONAL, -- Need N |
| sl-ConfigDedicatedNR-r16 | SetupRelease {SL-ConfigDedicatedNR-r16} |

OPTIONAL, -- Need M

| | |
|---|---|
| sl-ConfigDedicatedEUTRA-Info-r16 | SetupRelease {SL-ConfigDedicatedEUTRA- |
| Info-r16} | OPTIONAL, -- Need M |
| targetCellSMTC-SCG-r16 | SSB-MTC |

OPTIONAL, -- Need S

| | |
|---|---|
| nonCriticalExtension | SEQUENCE { RRCReconfiguration-v1710- |

| | |
|---|---|
| IEs } | OPTIONAL |

}

| RRCReconfiguration-v1710-IEs ::= | SEQUENCE { | |
|---|---|---|
| non-F1-terminating-Indication | ENUMERATED {true} | OPTIONAL, -- |

Need M

| | |
|---|---|
| nonCriticalExtension | SEQUENCE { } |

OPTIONAL
}

2) A new information element, non-F1-terminating-indication, is added into the IP address configuration list information element, IAB-IP-AddressConfigurationList, of the first RRC reconfiguration message, which is used to indicate that at least one IP address configuration carried by the RRC message is the IP address information of the non-F1-terminating topology domain, or is used to indicate that the at least one IP address configuration is generated by the non-F1-terminating donor.

The IP address configuration list information element may be expressed as follows by using an ASN.1 data format:

IAB-IP-AddressConfigurationList-r16 ::= SEQUENCE {

| | |
|---|---|
| iab-IP-AddressToAddModList-r16 | SEQUENCE (SIZE(1..maxIAB-IP-Address-r16)) |

OF IAB-IP-AddressConfiguration-r16 OPTIONAL, -- Need N

| iab-IP-AddressToReleaseList-r16 | SEQUENCE (SIZE(1..maxIAB-IP-Address-r16)) | |
|---|---|---|
| OF IAB-IP-AddressIndex-r16 | OPTIONAL, -- Need N | |
| non-F1-terminating-Indication | ENUMERATED {true} | OPTIONAL, -- |

Need M
...
}

With the indication modes in 1) and 2), all configured IP address information may be uniformly indicated that it is IP address information of the non-F1-terminating topology domain, thereby saving information bits.
3) A new information element, non-F1-terminating-indication, is added into the IP address configuration information element, IAB-IP-AddressConfiguration, of the first RRC reconfiguration message, which is used to indicate that an IP address configuration carried by the RRC message is the IP address information of the non-F1-terminating topology domain, or is used to indicate that the IP address configuration is generated by the non-F1-terminating donor.

The IP address configuration information element may be expressed as follows by using an ASN.1 data format:

| | |
|---|---|
| IAB-IP-AddressConfiguration-r16 ::= | SEQUENCE { |
| iab-IP-AddressIndex-r16 | IAB-IP-AddressIndex-r16, |
| iab-IP-Address-r16 | IAB-IP-Address-r16 |

OPTIONAL, -- Need M

| | |
|---|---|
| iab-IP-Usage-r16 | IAB-IP-Usage-r16 |

OPTIONAL, -- Need M

| | |
|---|---|
| iab-donor-DU-BAP-Address-r16 | BIT STRING (SIZE(10)) |

OPTIONAL, -- Need M

| | | |
|---|---|---|
| non-F1-terminating-Indication | ENUMERATED {true} | OPTIONAL, -- Need M |

...
}

4) A new information element, non-F1-terminating-indication, is added into the IP address index information element, IAB-IP-AddressIndexInfo, of the first RRC reconfiguration message, which is used to indicate that an IP address configuration carried by the RRC message is the IP address information of the non-F1-terminating topology domain, or is used to indicate that the IP address configuration is generated by the non-F1-terminating donor.

The IP address index information element may be expressed as follows by using an ASN.1 data format:

| IAB-IP-AddressIndexInfo-r17 ::= | SEQUENCE { | |
|---|---|---|
| iab-IP-AddressIndex-r17 | IAB-IP-AddressIndex-r17, | |
| non-F1-terminating-Indication | ENUMERATED {true} | OPTIONAL, -- Need |

M
...
}

With the indication modes in 3) and 4), indicated granularities may be for the configured IP address information, and the indication modes are more flexible.

### (II) For Dual-Connectivity Scenario 1

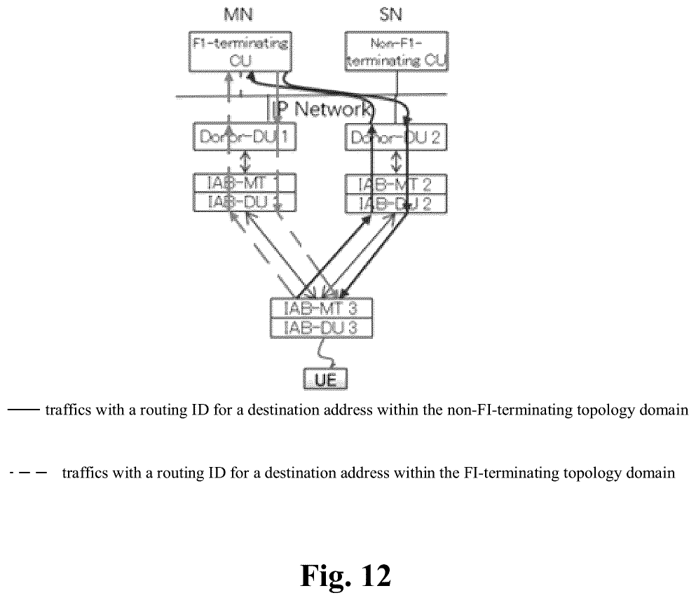

In some embodiments, FIG. 12 is a schematic diagram of dual-connectivity scenario 1. As shown in FIG. 12, in dual-connectivity scenario 1, a first IAB-donor (an F1-terminating donor) is a master node MN of the IAB node, and a second IAB-donor (a non-F1-terminating donor) is a secondary node SN of the IAB node. After dual-connectivity is established, a part of traffics of the boundary node may be migrated to the non-F1-terminating topology domain, and a part of traffics are still at an F1-terminating donor topology domain. The IP address of the non-F1-terminating topology domain refers to an IP address anchored at donor-DU2. The IP address of the non-F1-terminating topology domain may be configured during a process of establishing the dual-connectivity, or the IP address of the non-F1-terminating topology domain or the IP address of the F1-terminating topology domain is configured after the dual-connectivity is established. In implicit indication, the IAB node may determine that the at least one IP address configuration in the RRC message received via SRB3 contains the IP address information of the non-F1-terminating topology domain, or may determine that the at least one IP address configuration in the secondary cell group configuration information received via SRB1 contains the IP address information of the non-F1-terminating topology domain, or may determine that the at least one IP address configuration in the RRC message received via SRB1 contains the IP address information of the F1-terminating topology domain. In explicit indication, the IAB node may determine that the at least one IP address configuration in the secondary cell group configuration information received via SRB1 contains the IP address information of the non-F1-terminating topology domain when it receives the first indication information, and determine that the at least one IP address configuration in the secondary cell group configuration information received via SRB1 contains the IP address information of F1-terminating topology domain when it does not receive the first indication information, which shall be described below respectively.

In some embodiments, the IP address of the non-F1-terminating topology domain is configured in the process of adding a secondary cell group, and the first RRC reconfiguration message is an RRC reconfiguration message carried by secondary cell group configuration (mrdc-SecondaryCellGroupConfig field) of the RRC reconfiguration message, and is entirely carried by the second RRC reconfiguration message generated by the second donor and transmitted by the first IAB-donor; and the IAB node receives via SRB1 the second RRC reconfiguration message transmitted by the first IAB-donor. The first RRC reconfiguration message includes at least one IP address configuration for the IAB node, the at least one IP address configuration including the IP address information of the non-F1-terminating topology domain, the IP address of the non-F1-terminating topology domain referring to the IP address anchored at donor-DU2.

An ASN. 1 structure of the RRC reconfiguration message is as shown below, which includes the secondary cell group configuration (mrdc-SecondaryCellGroupConfig field).

| | |
|---|---|
| RRCReconfiguration ::= | SEQUENCE { |
| rrc-TransactionIdentifier | RRC-TransactionIdentifier, |
| criticalExtensions | CHOICE { |
| rrcReconfiguration | RRCReconfiguration-IEs, |
| criticalExtensionsFuture | SEQUENCE { } |

}
}

| | |
|---|---|
| RRCReconfiguration-IEs ::= | SEQUENCE { |
| radioBearerConfig | RadioBearerConfig |

OPTIONAL, -- Need M

| | |
|---|---|
| secondaryCellGroup | OCTET STRING (CONTAINING CellGroupConfig) |

OPTIONAL, -- Cond SCG

| | |
|---|---|
| measConfig | MeasConfig |

OPTIONAL, -- Need M

| | |
|---|---|
| lateNonCriticalExtension | OCTET STRING |

OPTIONAL,

| | |
|---|---|
| nonCriticalExtension | RRCReconfiguration-v1530-IEs |

OPTIONAL
}

| | |
|---|---|
| RRCReconfiguration-v1530-IEs ::= | SEQUENCE { |
| masterCellGroup | OCTET STRING (CONTAINING CellGroupConfig) |

OPTIONAL, -- Need M

| | |
|---|---|
| fullConfig | ENUMERATED {true} |

OPTIONAL, -- Cond FullConfig

| | |
|---|---|
| dedicatedNAS-MessageList | SEQUENCE (SIZE(1..maxDRB)) OF DedicatedNAS- |

| | |
|---|---|
| Message | OPTIONAL, -- Cond nonHO |

| | |
|---|---|
| masterKeyUpdate | MasterKeyUpdate |

OPTIONAL, -- Cond MasterKeyChange

| | |
|---|---|
| dedicatedSIB1-Delivery | OCTET STRING (CONTAINING SIB1) |

OPTIONAL, -- Need N

| | |
|---|---|
| dedicatedSystemInformationDelivery | OCTET STRING (CONTAINING SystemInformation) |

OPTIONAL, -- Need N

| | |
|---|---|
| otherConfig | OtherConfig |

OPTIONAL, -- Need M

| | |
|---|---|
| nonCriticalExtension | RRCReconfiguration-v1540-IEs |

OPTIONAL
}

| | |
|---|---|
| RRCReconfiguration-v1540-IEs ::= | SEQUENCE { |
| otherConfig-v1540 | OtherConfig-v1540 |

OPTIONAL, -- Need M

| | |
|---|---|
| nonCriticalExtension | RRCReconfiguration-v1560-IEs |

OPTIONAL
}

| RRCReconfiguration-v1560-IEs ::= | | SEQUENCE { |
|---|---|---|
| mrdc-SecondaryCellGroupConfig | | SetupRelease { MRDC-SecondaryCellGroupConfig } |
| OPTIONAL, | -- Need M | |
| radioBearerConfig2 | | OCTET STRING (CONTAINING RadioBearerConfig) |

| | |
|---|---|
| OPTIONAL, | -- Need M |

| | |
|---|---|
| sk-Counter | SK-Counter |

| | |
|---|---|
| OPTIONAL, | -- Need N |

| | |
|---|---|
| nonCriticalExtension | RRCReconfiguration-v1610-IEs |

OPTIONAL
}

| | |
|---|---|
| RRCReconfiguration-v1610-IEs ::= | SEQUENCE { |
| otherConfig-v1610 | OtherConfig-v1610 |

OPTIONAL, -- Need M

| | |
|---|---|
| bap-Config-r16 | SetupRelease { BAP-Config-r16 } |

OPTIONAL, -- Need M

| | |
|---|---|
| iab-IP-AddressConfigurationList-r16 | IAB-IP-AddressConfigurationList-r16 |

OPTIONAL, -- Need M

| | |
|---|---|
| conditionalReconfiguration-r16 | ConditionalReconfiguration-r16 |

OPTIONAL, -- Need M

| | |
|---|---|
| daps-SourceRelease-r16 | ENUMERATED {true} |

OPTIONAL, -- Need N

| | |
|---|---|
| t316-r16 | SetupRelease {T316-r16} |

OPTIONAL, -- Need M

| | |
|---|---|
| needForGapsConfigNR-r16 | SetupRelease {NeedForGapsConfigNR-r16} |

OPTIONAL, -- Need M

| | |
|---|---|
| onDemandSIB-Request-r16 | SetupRelease { OnDemandSIB-Request-r16 } |

OPTIONAL, -- Need M

| | |
|---|---|
| dedicatedPosSysInfoDelivery-r16 | OCTET STRING (CONTAINING PosSystemInformation- |

| | |
|---|---|
| r16-IEs) | OPTIONAL, -- Need N |

| | |
|---|---|
| sl-ConfigDedicatedNR-r16 | SetupRelease {SL-ConfigDedicatedNR-r16} |

OPTIONAL, -- Need M

| | |
|---|---|
| sl-ConfigDedicatedEUTRA-Info-r16 | SetupRelease {SL-ConfigDedicatedEUTRA-Info-r16} |

OPTIONAL, -- Need M

| | |
|---|---|
| targetCellSMTC-SCG-r16 | SSB-MTC |

OPTIONAL, -- Need S

| | |
|---|---|
| nonCriticalExtension | SEQUENCE { } |

OPTIONAL
}

| | |
|---|---|
| MRDC-SecondaryCellGroupConfig ::= | SEQUENCE { |
| mrdc-ReleaseAndAdd | ENUMERATED {true} |

| | |
|---|---|
| OPTIONAL, | -- Need N |

| | |
|---|---|
| mrdc-SecondaryCellGroup | CHOICE { |
| nr-SCG | OCTET STRING (CONTAINING |

RRCReconfiguration),

| | |
|---|---|
| eutra-SCG | OCTET STRING |

}
}

### (i) Implicit Indication

For example, the SN generates a secondary cell group configuration RRC message and transmits it to the MN in a secondary cell group addition response message. After receiving the secondary cell group configuration RRC message transmitted by the SN, the MN generates a second RRC reconfiguration message and forwards it to the IAB node in the mrdc-SecondaryCellGroupConfig field of the second RRC reconfiguration message. Therefore, after receiving the second RRC reconfiguration message via SRB1, the IAB node may obtain the RRC reconfiguration message contained in the mrdc-SecondaryCellGroupConfig field carried therein, and learns that the RRC reconfiguration message contained in the mrdc-SecondaryCellGroupConfig field is generated by the SN (i.e. at least one IP address configuration is provided by the SN), and the SN is a non-F1-terminating node. Therefore, the IAB node determines that the at least one IP address configuration carried by the RRC reconfiguration message contained in the mrdc-SecondaryCellGroupConfig field is the IP address information of the non-F1-terminating topology domain. That is, the IAB node determines that the at least one IP address configuration in the RRC reconfiguration message contained in the mrdc-SecondaryCellGroupConfig field received via SRB1 contains the IP address information of the non-F1-terminating topology domain.

### (ii) Explicit Indication

For example, when the SN generates the secondary cell group configuration RRC message, it may introduce a new information element, namely, first indication information non-F1-terminating, into the secondary cell group configuration RRC message, and transmit it to the MN in a secondary cell group addition response message. After receiving the secondary cell group configuration RRC message transmitted by the SN, the MN generates a second RRC reconfiguration message, and forwards the secondary cell group configuration RRC message to the IAB node in the mrdc-SecondaryCellGroupConfig field in the second RRC reconfiguration message. Hence, after receiving the second RRC reconfiguration message via SRB1, the IAB node may obtain the RRC reconfiguration message of the mrdc-SecondaryCellGroupConfig field carried therein and the first indication information contained therein. Therefore, the IAB node determines that the at least one IP address configuration carried by the RRC reconfiguration message of the mrdc-SecondaryCellGroupConfig field is the IP address information of the non-F1-terminating topology domain. The example of introducing the first indication information into the secondary cell group configuration RRC message is similar to those in 1)-4) above, which shall not be repeated herein any further.

For example, the SN generates a secondary cell group configuration RRC message and transmits it to the MN in the secondary cell group addition response message. After receiving the secondary cell group configuration RRC message transmitted by the SN, the MN generates a second RRC reconfiguration message, introduce a new information element, i.e. first indication information non-F1-terminating, into the second RRC reconfiguration message, and forward the secondary cell group configuration RRC message to the IAB node in the second RRC reconfiguration message. Therefore, after receiving the second RRC reconfiguration message via SRB1, the IAB node may obtain the RRC reconfiguration message and the first indication information of the mrdc-SecondaryCellGroupConfig field carried therein. Hence, the IAB node determines that the at least one IP address configuration carried by the RRC reconfiguration message of the mrdc-SecondaryCellGroupConfig field is the IP address information of the non-F1-terminating topology domain. The example of introducing the first indication information into the second RRC reconfiguration message is similar to that in 1) above, with a difference that when the second RRC reconfiguration message is generated, an information element iab-IP-AddressConfigurationList-r16 related to its own IP address configuration may not be included.

In some embodiments, the IP address of the non-F1-terminating topology domain may be configured (modified) after the dual-connectivity is established. The first RRC reconfiguration message is directly transmitted by the second IAB-donor to the IAB node, and the IAB node receives via SRB3 the first RRC reconfiguration message transmitted by the second IAB-donor. The first RRC reconfiguration message includes at least one IP address configuration for the IAB node, the at least one IP address configuration including IP address information of the non-F1-terminating topology domain, the IP address of the non-F1-terminating topology domain referring to the IP address anchored at donor-DU2.

### (i) Implicit Indication

For example, the IAB node receives the first RRC reconfiguration message via SRB3, and learns that the first RRC reconfiguration message is generated by the SN (i.e. at least one IP address configuration is provided by the SN), and the SN is a non-F1-terminating node. Hence, the IAB node determines that at least one IP address configuration carried by the first RRC reconfiguration message is the IP address information of the non-F1-terminating topology domain. That is, the IAB node determines that at least one IP address configuration in the first RRC reconfiguration message received via SRB1 contains the IP address information of the non-F1-terminating topology domain.

### (ii) Explicit Indication

For example, when the SN generates the first RRC reconfiguration message, a new information element, first indication information non-F1-terminating, may be introduced therein. The IAB node receives the first RRC reconfiguration message and the first indication information therein via SRB3, hence, the IAB node determines that at least one IP address configuration carried by the first RRC reconfiguration message is IP address information of the non-F1-terminating topology domain. The example of introducing the first indication information into the first RRC reconfiguration message is similar to those in 1)-4) above, which shall not be repeated herein any further.

In some embodiments, after the dual-connectivity is established, the IP address of the non-F1-terminating topology domain may be configured (modified) in a process of modifying the secondary cell group. The first RRC reconfiguration message is an RRC reconfiguration message contained in a mrdc-SecondaryCellGroupConfig field and is carried by the second RRC reconfiguration message transmitted by the first IAB-donor, and the IAB node receives via SRB1 the second RRC reconfiguration message transmitted by the first IAB-donor. The first RRC reconfiguration message includes at least one IP address configuration for the IAB node, the at least one IP address configuration including the IP address information of the non-F1-terminating topology domain, the IP address of the non-F1-terminating topology domain referring to the IP address anchored at donor-DU2.

### (i) Implicit Indication

For example, the SN generates a secondary cell group configuration RRC message and transmits it to the MN in a secondary cell group modification request message. After receiving the secondary cell group configuration RRC message transmitted by the SN, the MN generates a second RRC reconfiguration message and forwards it to the IAB node in a mrdc-SecondaryCellGroupConfig field of the second RRC reconfiguration message. Therefore, after receiving the second RRC reconfiguration message via SRB1, the IAB node may obtain the RRC reconfiguration messages contained in the mrdc-SecondaryCellGroupConfig field carried therein, and learns that the RRC reconfiguration message contained in the mrdc-SecondaryCellGroupConfig field is generated by the SN (i.e. at least one IP address configuration is provided by the SN), and SN is a non-F1-terminating node. Hence, the IAB node determines that at least one IP address configuration carried by the RRC message of the secondary cell group configuration is IP address information of the non-F1-terminating topology domain. That is, the IAB node determines that at least one IP address configuration in the RRC reconfiguration message contained in the mrdc-SecondaryCellGroupConfig field received via SRB1 contains the IP address information of the non-F1-terminating topology domain.

### (ii) Explicit Indication

For example, when the SN generates the secondary cell group configuration RRC message, a new information element, first indication information non-F1-terminating, may be introduced therein and transmitted to the MN in a secondary cell group modification request message. After receiving the secondary cell group configuration RRC message transmitted by the SN, the MN generates a second RRC reconfiguration message and forwards it to the IAB node in a mrdc-SecondaryCellGroupConfig field in the second RRC reconfiguration message. Therefore, after receiving the second RRC reconfiguration message via SRB1, the IAB node may obtain the RRC reconfiguration message contained in the mrdc-SecondaryCellGroupConfig field carried therein and the first indication information carried by the RRC reconfiguration message. Hence, the IAB node determines that at least one IP address configuration carried by the RRC reconfiguration message contained in the mrdc-SecondaryCellGroupConfig field is the IP address information of the non-F1-terminating topology domain. The example of introducing the first indication information into the secondary cell group reconfiguration RRC message is similar to those in 1)-4) above, which shall not be repeated herein any further.

For example, the SN generates the secondary cell group configuration RRC message and transmits it to the MN in the secondary cell group modification request message. After receiving the secondary cell group configuration RRC message transmitted by the SN, the MN generates a second RRC reconfiguration message, introduce a new information element, first indication information non-F1-terminating, into the second RRC reconfiguration message, and forwards the secondary cell group configuration RRC message to the IAB node in the mrdc-SecondaryCellGroupConfig field in the second RRC reconfiguration message. Therefore, after receiving the second RRC reconfiguration message via SRB1, the IAB node may obtain the RRC reconfiguration message contained in the mrdc-SecondaryCellGroupConfig field and the first indication information. Hence, the IAB node determines that at least one IP address configuration carried by the RRC reconfiguration message contained in the mrdc-SecondaryCellGroupConfig field is the IP address information of the non-F1-terminating topology domain. The example of introducing the first indication information into the second RRC reconfiguration message is similar to 1) above, with a difference that when the second RRC reconfiguration message is generated, information element iab-IP-AddressConfigurationList-r16 related to its own IP address configuration may not be included.

In some embodiments, after the dual-connectivity is established, the IP address of the non-F1-terminating topology domain may be reconfigured in a process of IAB transport migration management and transmitted to the IAB node by the MN.

### (i) Implicit Indication

The first RRC reconfiguration message is an RRC reconfiguration message contained in the mrdc-SecondaryCellGroupConfig field, and as the process of IAB transport migration management does not support the SN to generate a secondary cell group configuration RRC message, the first RRC reconfiguration message is generated by the first IAB-donor instead of the second IAB-donor and carried by the second RRC reconfiguration message transmitted by the first IAB-donor. The IAB node receives via SRB1 the second RRC reconfiguration message transmitted by the first IAB-donor. The first RRC reconfiguration message includes at least one IP address configuration for the IAB node, the at least one IP address configuration including the IP address information of the non-F1-terminating topology domain, the IP address of the non-F1-terminating topology domain referring to the IP address anchored at donor-DU2.

For example, the SN provides at least one IP address configuration and transmits it to the MN in an IAB transport migration management response message. After receiving the at least one IP address configuration, the MN generates the first RRC reconfiguration message instead of the second IAB-donor and forwards it to the IAB node in the second RRC reconfiguration message. Therefore, after receiving via SRB1 the second RRC reconfiguration message, the IAB node may obtain the RRC reconfiguration message contained in the mrdc-SecondaryCellGroupConfig field carried therein. The IAB node learns that the at least one IP address configuration in the RRC reconfiguration message contained in the mrdc-SecondaryCellGroupConfig field is provided by the SN, and the SN is a non-F1-terminating node. Hence, the IAB node determines that the at least one IP address configuration carried by the RRC message in the secondary cell group configuration is the IP address information of the non-F1-terminating topology domain. That is, the IAB node determines that the at least one IP address configuration in the RRC reconfiguration message contained in the mrdc-SecondaryCellGroupConfig field received via SRB1 contains the IP address information of the non-F1-terminating topology domain.

### (ii) Explicit Indication

The SN provides the MN with at least one IP address configuration, the first RRC reconfiguration message is generated by the MN, and the IAB node receives via SRB1 the second RRC reconfiguration message transmitted by the first IAB-donor. The first RRC reconfiguration message includes at least one IP address configuration for the IAB node, the at least one IP address configuration including the IP address information of the non-F1-terminating topology domain, the IP address of the non-F1-terminating topology domain referring to the IP address anchored at donor-DU2.

For example, the SN provides at least one IP address configuration and transmits it to the MN in the IAB transport migration management response message. After receiving the at least one IP address configuration, the MN generates a first RRC reconfiguration message, introduces a new information element, first indication information non-F1-terminating, into the first RRC reconfiguration message, and transmits the first RRC reconfiguration message to the IAB node. Therefore, after receiving the first RRC reconfiguration message via SRB1, the IAB node may obtain at least one IP address information carried therein and the first indication information. Hence, the IAB node determines that at least one IP address configuration carried by the first RRC reconfiguration message is the IP address information of the non-F1-terminating topology domain. The example of introducing the first indication information into the first RRC reconfiguration message is similar to those in 1)-4) above, which shall not be repeated herein any further.

In some embodiments, after the dual-connectivity is established, the IP address of the non-F1-terminating topology domain may be reconfigured in the process of IAB transport migration management, the first RRC reconfiguration message is generated by the SN and transmitted directly to the IAB node by the second IAB-donor; and the IAB node receives via SRB3 the first RRC reconfiguration message transmitted by the second IAB-donor. The first RRC reconfiguration message includes at least one IP address configuration for the IAB node, the at least one IP address configuration including the IP address information of the non-F1-terminating topology domain, the IP address of the non-F1-terminating topology domain referring to the IP address anchored at donor-DU2.

### (i) Implicit Indication

For example, the IAB node receives the first RRC reconfiguration message via SRB3, and learns that the first RRC reconfiguration message is generated by the SN (i.e. at least one IP address configuration is provided by the SN), and the SN is a non-F1-terminating node. Therefore, the IAB node determines that at least one IP address configuration carried by the first RRC reconfiguration message is the IP address information of the non-F1-terminating topology domain. That is, the IAB node determines that at least one IP address configuration in the first RRC reconfiguration message received via SRB1 contains the IP address information of the non-F1-terminating topology domain.

### (ii) Explicit Indication

For example, when the SN generates the first RRC reconfiguration message, a new information element, first indication information non-F1-terminating, may be introduced therein, and the IAB node receives the first RRC reconfiguration message and the first indication information therein via SRB3, hence, the IAB node determines that at least one IP address configuration carried by the first RRC reconfiguration message is the IP address information of the non-F1-terminating topology domain. The example of introducing the first indication information into the first RRC reconfiguration message is similar to those in 1)-4) above, which shall not be repeated herein any further.

In some embodiments, after the dual-connectivity is established, the IP address of the F1-terminating topology domain may be configured (modified) in a process of modifying the secondary cell group. The first RRC reconfiguration message is generated by the MN and transmitted directly to the IAB node by the first IAB-donor; the IAB node receives via SRB1 the first RRC reconfiguration message transmitted by the first IAB-donor. The first RRC reconfiguration message includes at least one IP address configuration for the IAB node, the at least one IP address configuration including the IP address information of the F1-terminating topology domain, the IP address of the F1-terminating topology domain referring to the IP address anchored at donor-DU1.

### (i) Implicit Indication

For example, the IAB node receives the first RRC reconfiguration message via SRB1 and learns that the first RRC reconfiguration message is generated by the MN (i.e. at least one IP address configuration is provided by the MN), and the MN is an F1-terminating node, therefore, the IAB node determines that at least one IP address configuration carried by the first RRC reconfiguration message is the IP address information of the F1-terminating topology domain. That is, the IAB node determines that at least one IP address configuration in the first RRC reconfiguration message received via SRB1 contains IP address information of the F1-terminating topology domain.

### (ii) Explicit Indication

For example, when the MN generates the first RRC reconfiguration message, there is no need to introduce a new information element, first indication information non-F1-terminating, into the first RRC reconfiguration message, and the IAB node receives the first RRC reconfiguration message via SRB1. As it does not contain the first indication information, i.e. the IAB node does not receive the first indication information, the IAB node determines that at least one IP address configuration carried by the first RRC reconfiguration message is the IP address information of the F1-terminating topology domain.

### (III) For Dual-Connectivity Scenario 2

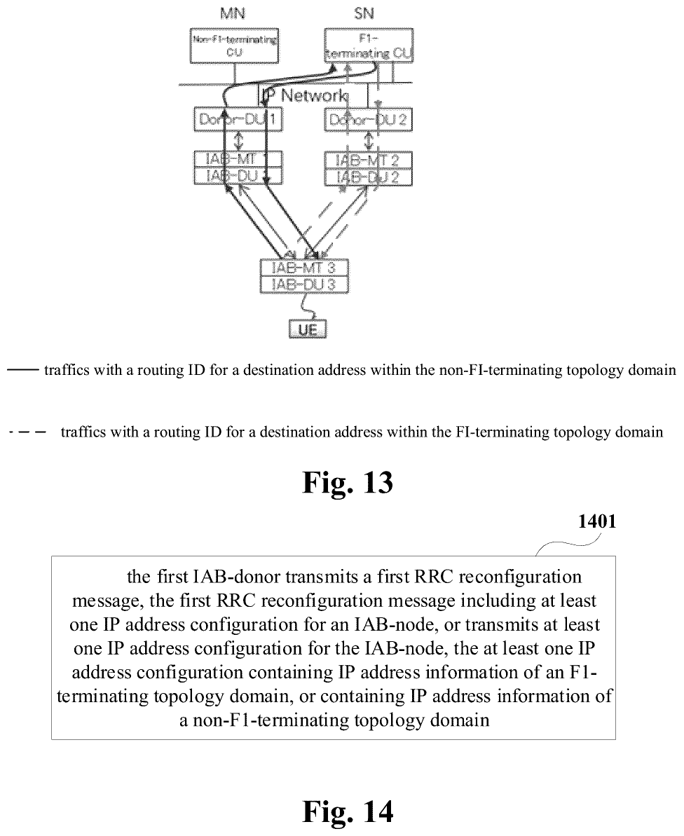

In some embodiments, FIG. 13 is a schematic diagram of dual-connectivity scenario 2. As shown in FIG. 13, in dual-connectivity scenario 2, the first IAB-donor (F1-terminating donor) is a secondary node SN of the IAB node, and the second IAB-donor (non-F1-terminating donor) is a master node MN of the IAB node. After dual-connectivity is established, some of traffics of the boundary node may be migrated to the non-F1-terminating topology domain, while some of the traffics still remains in the F1-terminating donor topology domain. The IP address of the non-F1-terminating topology domain refers to an IP address anchored at donor-DU1, while the IP address of the F1-terminating topology domain refers to an IP address anchored at donor-DU2. As F1 connection is completed after the dual-connectivity is established, unlike dual-connectivity scenario 1, the IP address of the non-F1-terminating topology domain may not be configured in the process of establishing dual-connectivity, and the IP address of the non-F1-terminating topology domain or the IP address of the F1-terminating topology domain may only be configured after the dual-connectivity is established. In implicit indication, the IAB node may determine that the at least one IP address configuration in the RRC message received via SRB1 contains the IP address information of the non-F1-terminating topology domain, or may determine that the at least one IP address configuration in the secondary cell group configuration information received via SRB1 contains the IP address information of the F1-terminating topology domain, or may determine that the at least one IP address configuration in the RRC message received via SRB3 contains the IP address information of the F1-terminating topology domain. In explicit indication, the IAB node may determine that the at least one IP address configuration in the first RRC reconfiguration message contains the IP address information of the non-F1-terminating topology domain when the first indication information is received, and determine that the at least one IP address configuration in the first RRC reconfiguration message contains the IP address information of the F1-terminating topology domain when the first indication information is not received, which shall be described below respectively.

In some embodiments, the IP address of the non-F1-terminating topology domain may be configured (modified) after the dual-connectivity is established. The first RRC reconfiguration message is transmitted by the second IAB-donor to the IAB node, and the IAB node receives via SRB1 the first RRC reconfiguration message transmitted by the second IAB-donor. The first RRC reconfiguration message includes at least one IP address configuration for the IAB node, the at least one IP address configuration including the IP address information of the non-F1-terminating topology domain, the IP address of the non-F1-terminating topology domain referring to the IP address anchored at donor-DU1.

### (i) Implicit Indication

For example, the IAB node receives the first RRC reconfiguration message via SRB1, and learns that the first RRC reconfiguration message is generated by the MN (i.e. at least one IP address configuration is provided by the MN), and MN is a non-F1-terminating node. Therefore, the IAB node determines that at least one IP address configuration carried by the first RRC reconfiguration message is the IP address information of the non-F1-terminating topology domain. That is, the IAB node determines that at least one IP address configuration in the first RRC reconfiguration message received via SRB1 contains the IP address information of the non-F1-terminating topology domain.

### (ii) Explicit Indication

For example, when the MN generates the first RRC reconfiguration message, a new information element, first indication information non-F1-terminating, may be introduced therein, and the IAB node receives the first RRC reconfiguration message and the first indication information therein via SRB1, hence, the IAB node determines that at least one IP address configuration carried by the first RRC reconfiguration message is the IP address information of the non-F1-terminating topology domain. The example of introducing the first indication formation into the first RRC reconfiguration message is similar to those in 1)-4) above, which shall not be repeated herein any further.

In some embodiments, after the dual-connectivity is established, the IP address of the F1-terminating topology domain may be configured (modified) in a process of modifying the secondary cell group. The first RRC reconfiguration message is generated by the first IAB-donor; the IAB node receives via SRB3 the first RRC reconfiguration message transmitted by the first IAB-donor. The first RRC reconfiguration message includes at least one IP address configuration for the IAB node, the at least one IP address configuration including the IP address information of the F1-terminating topology domain, the IP address of the F1-terminating topology domain referring to the IP address anchored at donor-DU2.

### (i) Implicit Indication

For example, the IAB node receives the first RRC reconfiguration message via SRB3 and learns that the first RRC reconfiguration message is generated by the SN (i.e. at least one IP address configuration is provided by the SN), and the SN is an F1-terminating node. Therefore, the IAB node determines that at least one IP address configuration carried by the first RRC reconfiguration message is the IP address information of the F1-terminating topology domain. That is, the IAB node determines that at least one IP address configuration in the first RRC reconfiguration message received via SRB3 contains the IP address information of the F1-terminating topology domain.

### (ii) Explicit Indication

For example, when the SN generates the first RRC reconfiguration message, there is no need to introduce a new information element, first indication information non-F1-terminating, into it.

The IAB node receives the first RRC reconfiguration message via SRB3, and as the IAB node does not receive the first indication information, it determines that at least one IP address configuration in the first RRC reconfiguration message received via SRB3 includes the IP address information of the F1-terminating topology domain.

In some embodiments, after the dual-connectivity is established, the IP address of the F1-terminating topology domain may be configured (modified) in a process of modifying the secondary cell group. The first RRC reconfiguration message is an RRC reconfiguration message contained in a mrdc-SecondaryCellGroupConfig field of the RRC reconfiguration message, entirely generated by the first IAB-donor and carried by a third RRC reconfiguration message transmitted by the second IAB-donor; and the IAB node receives via SRB1 the third RRC reconfiguration message transmitted by the second IAB-donor. The first RRC reconfiguration message includes at least one IP address configuration for the IAB node, the at least one IP address configuration including IP address information of the F1-terminating topology domain, the IP address of the F1-terminating topology domain referring to the IP address anchored at donor-DU2.

### (i) Implicit Indication

For example, the SN generates a secondary cell group configuration RRC message and transmits it to the MN in a secondary cell group modification request message. After receiving the secondary cell group configuration RRC message transmitted by the SN, the MN generates the third RRC reconfiguration message and forwards the secondary cell group configuration RRC message to the IAB node in a mrdc-SecondaryCellGroupConfig field of the third RRC reconfiguration message. Therefore, after receiving the third RRC reconfiguration message via SRB1, the IAB node may obtain the RRC reconfiguration message contained in the mrdc-SecondaryCellGroupConfig field carried therein. The IAB node learns that the RRC reconfiguration message contained in the mrdc-SecondaryCellGroupConfig field is generated by the SN (i.e. at least one IP address configuration is provided by the SN), and the SN is an F1-terminating node. Hence, the IAB node determines that at least one IP address configuration carried by the RRC reconfiguration message contained in the mrdc-SecondaryCellGroupConfig field is the IP address information of the F1-terminating topology domain. That is, the IAB node determines that at least one IP address configuration in the secondary cell group configuration RRC message received via SRB1 contains the IP address information of the F1-terminating topology domain.

### (ii) Explicit Indication

For example, when the SN generates the secondary cell group configuration RRC message, it needs not to introduce a new information element therein, i.e. first indication information non-F1-terminating, and transmits the secondary cell group configuration RRC message to the MN in the secondary cell group modification request message. After receiving the secondary cell group configuration RRC message transmitted by the SN, the MN generates the third RRC reconfiguration message and forwards it to the IAB node in the mrdc-SecondaryCellGroupConfig field in the third RRC reconfiguration message. Therefore, after receiving the third RRC reconfiguration message via SRB1, the IAB node may obtain the RRC reconfiguration message contained in the mrdc-SecondaryCellGroupConfig field carried therein. However, as neither the first RRC reconfiguration message nor the third RRC reconfiguration message contains the first indication information, i.e. the IAB node does not receive the first indication information, the IAB node determines that at least one IP address configuration carried by the secondary cell group configuration RRC message is the IP address information of the F1-terminating topology domain.

In some embodiments, after the dual-connectivity is established, the IP address of the non-F1-terminating topology domain may be configured (modified) in the process of IAB transport migration management. The first RRC reconfiguration message is generated by the second IAB-donor and transmitted to the IAB node by the second IAB-donor, and the IAB node receives via SRB1 the first RRC reconfiguration message transmitted by the second IAB-donor. The first RRC reconfiguration message includes at least one IP address configuration for the IAB node, the at least one IP address configuration including the IP address information of the non-F1-terminating topology domain, the IP address of the non-F1-terminating topology domain referring to the IP address anchored at donor-DU1.

### (i) Implicit Indication

For example, the SN transmits an IAB transport migration management request message to the MN, and the MN (the second IAB-donor, a non-F1-terminating donor) generates the first RRC reconfiguration message upon receiving the request message, the at least one IP address configuration including the IP address information of the non-F1-terminating topology domain, and transmits the first RRC reconfiguration message to the IAB node. Therefore, after receiving the first RRC reconfiguration message via SRB1, the IAB node may obtain at least one IP address configuration carried therein, and learns that the at least one IP address configuration is provided by the MN, which is a non-F1-terminating node. Hence, the IAB node determines that the at least one IP address configuration carried by the first RRC reconfiguration message is the IP address information of the non-F1-terminating topology domain. That is, the IAB node determines that at least one IP address configuration in the first RRC reconfiguration message received via SRB1 contains the IP address information of the non-F1-terminating topology domain.

### (ii) Explicit Indication

For example, the SN transmits the IAB transport migration management request message to the MN. After receiving the request message, the MN (the second IAB-donor, a non-F1-terminating donor) generates the first RRC reconfiguration message, and may introduce a new information element, first indication information non-F1-terminating, into the first RRC reconfiguration message, and transmit the first RRC reconfiguration message to the IAB node. Therefore, after receiving the first RRC reconfiguration message via SRB1, the IAB node may obtain at least one IP address information and the first indication information carried therein. Hence, the IAB node determines that at least one IP address configuration carried by the first RRC reconfiguration message is the IP address information of the non-F1-terminating topology domain. The example of introducing the first indication information into the first RRC reconfiguration message is similar to those in 1)-4) above, which shall not be repeated herein any further.

In some embodiments, after the dual-connectivity is established, the IP address of the F1-terminating topology domain may be configured (modified) in the process of IAB transport migration management. The first RRC reconfiguration message is generated by the second IAB-donor instead of the first IAB-donor and transmitted to the IAB node by the second IAB-donor. The IAB node receives via SRB1 the first RRC reconfiguration message transmitted by the second IAB-donor. The first RRC reconfiguration message includes at least one IP address configuration for the IAB node, the at least one IP address configuration including the IP address information of the F1-terminating topology domain, the IP address of the F1-terminating topology domain referring to the IP address anchored at donor-DU2.

### (i) Implicit Indication

For example, the SN provides at least one IP address configuration (including the IP address information of the F1-terminating topology domain) and transmits it to the MN (the second IAB-donor, not the F1-terminating donor) in the IAB transport migration modification request message. After receiving the request message, the MN generates a secondary cell configuration RRC message instead of the SN, the at least one IP address configuration including the IP address information of the F1-terminating topology domain, generates a third RRC reconfiguration message, and forwards the first RRC reconfiguration message to the IAB node in a mrdc-SecondaryCellGroupConfig field of the third RRC reconfiguration message. Therefore, after receiving the third RRC reconfiguration message via SRB1, the IAB node may obtain the RRC reconfiguration message contained in the mrdc-SecondaryCellGroupConfig field carried therein, and learns that at least one IP address configuration in the RRC reconfiguration message contained in the mrdc-SecondaryCellGroupConfig field is provided by the SN, which is an F1-terminating donor. Hence, the IAB node determines that at least one IP address configuration carried in the first RRC reconfiguration message is the IP address information of the F1-terminating topology domain. That is, the IAB node determines that at least one IP address configuration of the RRC reconfiguration message contained in the mrdc-SecondaryCellGroupConfig field in the first RRC reconfiguration message received via SRB1 contains the IP address information of the F1-terminating topology domain.

### (ii) Explicit Indication

The SN provides at least one IP address configuration (including the IP address information of the F1-terminating topology domain), and transmits it to the MN (the second IAB-donor, not the F1-terminating donor) in the IAB transport migration modification request message. After receiving the request message, the MN generates the first RRC reconfiguration message, wherein the at least one IP address configuration includes the IP address information of the F1-terminating topology domain, but there is no need to introduce first indication information into the first RRC reconfiguration message. As the first indication information is not included in the first RRC reconfiguration message, that is, the IAB node does not receive the first indication information, the IAB node determines that at least one IP address configuration carried by the RRC message is the IP address information of the F1-terminating topology domain.

How to configure and indicate the IP addresses of the non-F1-terminating topology domain or the F1-terminating topology domain and how the IAB node distinguish the configured IP address is the IP address of the non-F1-terminating topology domain or the IP address of the F1-terminating topology domain are described above. In the above embodiments, the IAB node may learn whether the MN or the SN is the F1-terminating donor or the non-F1-terminating donor. For example, the IAB node may determine whether the MN or the SN is the F1-terminating donor according to which donor provides the received BAP configuration information (bap-config-r16 field).

In the above explicit indications, how to determine whether the configured IP address is the IP address of the non-F1-terminating topology domain or the IP address of the F1-terminating topology domain is described by taking whether the first indication information is received as an example; however, this disclosure is not limited thereto. For example, the first indication information is used to indicate whether the IP address configuration includes the IP address information of the non-F1-terminating topology domain, or the first indication information is used to indicate whether the IP address configuration includes the IP address information of the non-F1-terminating topology domain or the IP address information of the F1-terminating topology domain. For example, when the IAB receives the first indication information and a value of the first indication information is a first value (true or 1), it is determined that the IP address configuration includes the IP address information of the non-F1-terminating topology domain, and when a value of the first indication information is a second value (false or 0), it is determined that the IP address configuration includes the IP address information of the F1-terminating topology domain. A particular process is identical to that described above, which shall not be enumerated herein any further.

The above signaling process only illustrates the embodiments of this disclosure; however, this disclosure is not limited thereto, and reference may be made to relevant techniques for more detailed contents. Furthermore, for example, an order of execution of the operations may be appropriately adjusted, and moreover, some other operations may be added, or some operations therein may be reduced. And appropriate variants may be made by those skilled in the art according to the above contents, without being limited to what is contained in FIG. 10.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It can be seen from the above embodiments that the IP address of the non-F1-terminating topology domain or the IP address of the F1-terminating topology domain may be configured to enabled to respectively transmit traffics with routing IDs belonging to the F1-terminating topology domain and traffics with routing IDs belonging to the non-F1-terminating topology domain.

### Embodiments of a Second Aspect

The embodiments of this disclosure provide a transport address determination method, which shall be described from a first IAB-donor, with contents identical to those in the embodiments of the first aspect being not going to be described herein any further.

FIG. 14 is a schematic diagram of a transport address determination method of the embodiments of this disclosure. As shown in FIG. 14, the method includes:
1401: the first IAB-donor transmits a first RRC reconfiguration message, the first RRC reconfiguration message including at least one IP address configuration for an IAB node, or transmits at least one IP address configuration for the IAB node,
the at least one IP address configuration containing IP address information of an F1-terminating topology domain, or containing IP address information of a non-F1-terminating topology domain.

In some embodiments, the first IAB-donor may transmit the first RRC reconfiguration message to the IAB node or a second IAB-donor, F1 connection of the IAB node is terminated at the first IAB-donor, and there exists RRC connection between the IAB node and the second IAB-donor.

In some embodiments, whether the configured IP address belongs to the non-F1-terminating topology domain may be implicitly indicated, or whether the configured IP address belongs to the non-F1-terminating topology domain may be explicitly indicated. For example, the first IAB-donor indicates via the first indication information that the IP address configuration includes the IP address information of the F1-terminating topology domain or includes the IP address information of the non-F1-terminating topology domain.

In some embodiments, the IP address configuration includes the IP address information of the non-F1-terminating topology domain.

In some embodiments, the first IAB-donor is a source donor for handover of the IAB node, the second IAB-donor is a target donor for handover of the IAB node, and the first RRC reconfiguration message is a handover command RRC message. The method may further include: the first IAB-donor receives, a first RRC reconfiguration message transmitted by the second IAB-donor. In 1401, the first IAB-donor forwards the first RRC reconfiguration message generated by the second IAB-donor to the IAB node.

In some embodiments, the first IAB-donor is a master node MN of the IAB node, and the second IAB-donor is a secondary node SN of the IAB node.

For example, the first RRC reconfiguration message is an RRC reconfiguration message contained in a secondary cell group configuration field of the RRC reconfiguration message and carried by a second RRC reconfiguration message transmitted by the first IAB-donor, and the first IAB-donor transmits the second RRC reconfiguration message to the IAB node via SRB1.

The method further includes: the first IAB-donor receives, the first RRC reconfiguration message transmitted by the second IAB-donor (the first RRC reconfiguration message being generated by the second IAB-donor). And in 1401, the first IAB-donor transmits the second RRC reconfiguration message (the second RRC reconfiguration message is generated by the first IAB-donor) to the IAB node via SRB1, the second RRC reconfiguration message carrying the first RRC reconfiguration message.

Or, the method may further include: the first IAB-donor receives the IP address configuration provided by the second IAB-donor and generates the first RRC reconfiguration message instead of the second IAB-donor. And in 1401, the first IAB-donor transmits the second RRC reconfiguration message (the second RRC reconfiguration message is also generated by the first IAB-donor) to the IAB node via SRB1, the second RRC reconfiguration message carrying the first RRC reconfiguration message.

For example, the method may further include: the first IAB-donor receives the IP address configuration provided by the second IAB-donor and generates the first RRC reconfiguration message. And in 1401, the first IAB-donor transmits the first RRC reconfiguration message to the IAB node via SRB1.

In the above embodiments, the IP address configuration includes the IP address information of the non-F1-terminating topology domain. In explicit indication, the first IAB-donor indicates that the IP address configuration includes the IP address information of the non-F1-terminating topology domain by containing the first indication information in the first RRC reconfiguration message or the second RRC reconfiguration message. The first indication information is included in a newly-added information element of the first RRC reconfiguration message or the second RRC reconfiguration message, or in an IP address configuration list information element of the first RRC reconfiguration message or the second RRC reconfiguration message, or in an IP address configuration information element of the first RRC reconfiguration message or the second RRC reconfiguration message, or in an IP address index information element of the first RRC reconfiguration message or the second RRC reconfiguration message.

In some embodiments, the IP address configuration includes the IP address information of the F1-terminating topology domain.

In some embodiments, the first IAB-donor is an SN of the IAB node, and the second IAB-donor is an MN of the IAB node.

For example, in 1401, the first IAB-donor transmits the first RRC reconfiguration message to the IAB node via SRB3.

For example, in 1401, the first IAB-donor transmits the first RRC reconfiguration message to the second IAB-donor, wherein the first RRC reconfiguration message is a secondary cell group configuration RRC message.

For example, in 1401, the first IAB-donor transmits the IP address configuration to the second IAB-donor, the IP address configuration being carried by an IAB transport migration modification request message.

In some embodiments, the first IAB-donor is a master node MN of the IAB node, and the second IAB-donor is a secondary node SN of the IAB node.

For example, the first IAB-donor transmits the first RRC reconfiguration message to the IAB node via SRB1.

In the above embodiments, the IP address configuration includes the IP address information of the F1-terminating topology domain. In explicit indication, the first IAB-donor indicates that the IP address configuration contains the IP address information of the F1-terminating topology domain by not containing the first indication information in the first RRC reconfiguration message.

It should be noted that FIG. 14 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 14.

It can be seen from the above embodiments that the IP address of the non-F1-terminating topology domain or the IP address of the F1-terminating topology domain may be configured to the IAB node via the first RRC reconfiguration message. Hence, the boundary node may be enabled to respectively transmit traffics with routing IDs belonging to the F1-terminating topology domain and traffics with routing IDs belonging to the non-F1-terminating topology domain.

### Embodiments of a Third Aspect

The embodiments of this disclosure provide a transport address determination method, which shall be described from a second IAB-donor.

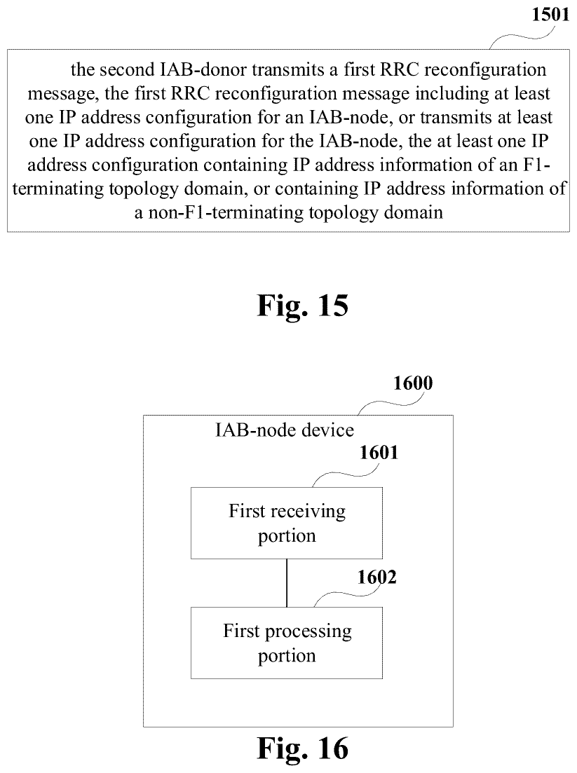

FIG. 15 is a schematic diagram of a transport address determination method of the embodiments of this disclosure. As shown in FIG. 15, the method includes:
1501: the second IAB-donor transmits a first RRC reconfiguration message, the first RRC reconfiguration message including at least one IP address configuration for an IAB node, or transmits at least one IP address configuration for the IAB node,
the at least one IP address configuration containing IP address information of an F1-terminating topology domain, or containing IP address information of a non-F1-terminating topology domain.

In some embodiments, the second IAB-donor may transmit the first RRC reconfiguration message to the IAB node or the first IAB-donor, F1 connection of the IAB node is terminated at the first IAB-donor, and there exists RRC connection between the IAB node and the second IAB-donor.

In some embodiments, whether the configured IP address belongs to the non-F1-terminating topology domain may be implicitly indicated, or whether the configured IP address belongs to the non-F1-terminating topology domain may be explicitly indicated. For example, the second IAB-donor indicates via the first indication information that the IP address configuration includes the IP address information of the F1-terminating topology domain or includes the IP address information of the non-F1-terminating topology domain.

In some embodiments, the IP address configuration includes the IP address information of the non-F1-terminating topology domain.

In some embodiments, the first IAB-donor is a source donor for handover of the IAB node, the second IAB-donor is a target donor for handover of the IAB node, and the first RRC reconfiguration message is a handover command RRC message. And in 1501, the second IAB-donor transmits the first RRC reconfiguration message to the first IAB-donor.

In some embodiments, the first IAB-donor is a master node MN of the IAB node, and the second IAB-donor is a secondary node SN of the IAB node.

For example, in 1501, the second IAB-donor transmits the first RRC reconfiguration message to the first IAB node;

or, for example, in 1501, the second IAB-donor transmits the IP address configuration to the first IAB-donor.

For example, in 1501, the second IAB-donor transmits the first RRC configuration message to the IAB-donor via SRB3.

In some embodiments, the second IAB-donor is a master node MN of the IAB node, and the first IAB-donor is a secondary node SN of the IAB node.

For example, in 1501, the second IAB-donor transmits the first RRC reconfiguration message to the IAB node via SRB1.

In the above embodiments, the IP address configuration includes the IP address information of the non-F1-terminating topology domain. In explicit indication, the second IAB-donor indicates that the IP address configuration contains the IP address information of the non-F1-terminating topology domain by containing the first indication information in the first RRC reconfiguration message. The first indication information is contained in a newly-added information element of the first RRC reconfiguration message, or contained in an IP address configuration list information element of the first RRC reconfiguration message, or contained in an IP address configuration information element of the first RRC reconfiguration message, or contained in an IP address index information element of the first RRC reconfiguration message.

In some embodiments, the IP address configuration includes the IP address information of the F1-terminating topology domain.

In some embodiments, the first IAB-donor is an SN of the IAB node, and the second IAB-donor is an MN of the IAB node.

For example, the first RRC reconfiguration message is an RRC reconfiguration message contained in a secondary cell group configuration field in the RRC reconfiguration message and carried by a third RRC reconfiguration message transmitted by the second IAB-donor; and in 1501, the second IAB-donor transmits the third RRC reconfiguration message to the IAB node via SRB1.

The method further includes: the second IAB-donor receives, the first RRC reconfiguration message transmitted by the first IAB-donor.

For example, in 1501, the second IAB-donor receives the IP address configuration provided by the first IAB-donor, and generates the first RRC reconfiguration message instead of the first IAB-donor.

For example, the method may further include: the second IAB-donor receives, the IP address configuration transmitted by the first IAB-donor. And in 1501, the second IAB-donor transmits the first RRC reconfiguration message to the IAB node via SRB1.

In the above embodiments, the IP address configuration includes the IP address information of the non-F1-terminating topology domain. In explicit indication, the first IAB-donor indicates that the IP address configuration includes the IP address information of the F1-terminating topology domain by not containing the first indication information in the first RRC reconfiguration message or the third RRC reconfiguration message.

It should be noted that FIG. 15 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 15.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It can be seen from the above embodiments that the IP address of the non-F1-terminating topology domain or the IP address of the F1-terminating topology domain may be configured to the IAB node via the first RRC reconfiguration message. Hence, the boundary node may be enabled to respectively transmit traffics with routing IDs belonging to the F1-terminating topology domain and traffics with routing IDs belonging to the non-F1-terminating topology domain.

### Embodiments of a Fourth Aspect

The embodiments of this disclosure provide an IAB node device, with contents identical to those in the embodiments of the first aspect being not going to be described herein any further.

The device may be, for example, an IAB node (such as the boundary node in the embodiments of the first aspect) in an IAB system, or may be one or more components or assemblies or modules configured in the IAB node.

FIG. 16 is a schematic diagram of the IAB node device of the embodiments of this disclosure. As shown in FIG. 16, an IAB node device 1600 includes:
a first receiving portion 1601 configured to receive a first RRC reconfiguration message, the first RRC reconfiguration message including at least one IP address configuration for the IAB node,
the at least one IP address configuration containing IP address information of an F1-terminating topology domain, or containing IP address information of a non-F1-terminating topology domain.

In some embodiments, F1 connection of the IAB node is terminated at a first IAB-donor, and the IAB node has RRC connection with a second IAB-donor.

In some embodiments, the device further includes:
a first processing portion 1602 configured to determine that the IP address configuration includes IP address information of an F1-terminating topology domain or IP address information of a non-F1-terminating topology domain.

In some embodiments, the first processing portion determines according to first indication information that the IP address configuration includes the IP address information of the F1-terminating topology domain or the IP address information of the non-F1-terminating topology domain.

In some embodiments, the first processing portion determines that the IP address configuration includes IP address information of the non-F1-terminating topology domain.

In some embodiments, the first IAB-donor is a source donor for handover of the IAB node, and the second IAB-donor is a target donor for handover of the IAB node; and the first RRC reconfiguration message is a handover command RRC message generated by the second IAB-donor and forwarded by the first IAB-donor.

In some embodiments, the first IAB-donor is a master node MN of the IAB node, and the second IAB-donor is a secondary node SN of the IAB node.

For example, the first RRC reconfiguration message is an RRC reconfiguration message contained in a secondary cell group configuration field in the RRC reconfiguration message, and is carried by a second RRC reconfiguration message transmitted by the first IAB-donor; and the first receiving portion receives via SRB1 the second RRC reconfiguration message transmitted by the first IAB-donor. Alternatively, the first RRC reconfiguration message is generated by the first IAB-donor instead of the second IAB-donor.

For example, the first receiving portion receives via SRB3 the first RRC reconfiguration message transmitted by the second IAB-donor.

For example, the first receiving portion receives via SRB1 the first RRC reconfiguration message transmitted by the first IAB-donor.

In some embodiments, the first IAB-donor is the SN of the IAB node, and the second IAB-donor is the MN of the IAB node; and the first receiving portion receives via SRB1 the first RRC reconfiguration message transmitted by the second IAB-donor.

In some embodiments, the first processing portion determines that the IP address configuration contains the IP address information of the non-F1-terminating topology domain when the first RRC reconfiguration message or the second RRC reconfiguration message contains the first indication information. The first indication information is included in a newly-added information element of the first RRC reconfiguration message or the second RRC reconfiguration message, or is included in an IP address configuration list information element of the first RRC reconfiguration message or the second RRC reconfiguration message, or is included in an IP address configuration information element of the first RRC reconfiguration message or the second RRC reconfiguration message, or is included in an IP address index information element of the first RRC reconfiguration message or the second RRC reconfiguration message.

In some embodiments, the first processing portion determines that the IP address configuration includes the IP address information of the F1-terminating topology domain.

In some embodiments, the first IAB-donor is a master node MN of the IAB node, and the second IAB-donor is a secondary node SN of the IAB node; and, the first receiving portion receives via SRB1 the first RRC reconfiguration message transmitted by the first IAB-donor.

In some embodiments, the first IAB-donor is an SN of the IAB node, and the second IAB-donor is an MN of the IAB node

For example, the first RRC reconfiguration message is an RRC reconfiguration message contained in a secondary cell configuration domain in the RRC reconfiguration message, and is carried by a third RRC reconfiguration message transmitted by the second IAB-donor; and the first receiving portion receives via SRB1 the third RRC reconfiguration message transmitted by the second IAB-donor. Alternatively, the first RRC reconfiguration message is generated by the second IAB-donor instead of the first IAB-donor.

For example, the first receiving portion receives via SRB3 the first RRC reconfiguration message transmitted by the first IAB-donor.

For example, the first receiving portion receives via SRB1 the first RRC reconfiguration message transmitted by the second IAB-donor.

In some embodiments, the first processing portion determines that the IP address configuration contains the IP address information of the F1-terminating topology domain when the first RRC reconfiguration message or the third RRC reconfiguration message does not contain the first indication information.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the IAB node device 1600 may further include other components or modules, and reference may be made to related techniques for particulars of these components or modules.

Furthermore, for the sake of simplicity, connection relationships between the components or modules or signal profiles thereof are only illustrated in FIG. 16. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

It can be seen from the above embodiments that the IP address of the non-F1-terminating topology domain or the IP address of the F1-terminating topology domain may be configured to the IAB node via the first RRC reconfiguration message. Hence, the boundary node may be enabled to respectively transmit traffics with routing IDs belonging to the F1-terminating topology domain and traffics with routing IDs belonging to the non-F1-terminating topology domain.

### Embodiments of a Fifth Aspect

The embodiments of this disclosure provide an IAB-donor device, with contents identical to those in the embodiments of the second aspect being not going to be described herein any further. The device may be, for example, an IAB-donor-CU (such as the first IAB-donor in the embodiments of the first, second and third aspects) in an IAB system, or may be one or more components or assemblies or modules configured in the IAB-donor-CU.

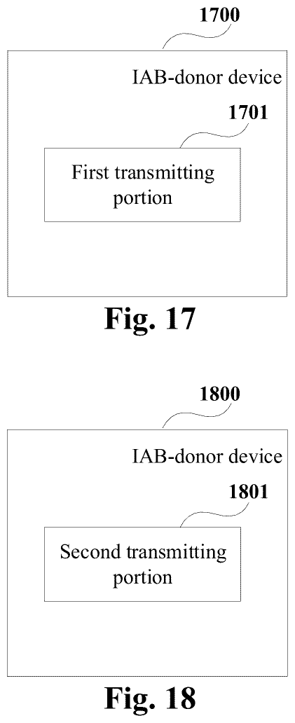

FIG. 17 is a schematic diagram of the IAB-donor device of the embodiments of this disclosure. As shown in FIG. 17, an IAB-donor device 1700 includes:
a first transmitting portion 1701 configured to transmit a first RRC reconfiguration message, the first RRC reconfiguration message including at least one IP address configuration for an IAB node, or, transmit at least one IP address configuration of the IAB node,
the at least one IP address configuration including IP address information of an F1-terminating topology domain, or including IP address information of a non-F1-terminating topology domain;
wherein F1 connection of the IAB node is terminated at the first IAB-donor, and the IAB node has RRC connection with a second IAB-donor.

In some embodiments, the IAB-donor device indicates that the IP address configuration includes the IP address information of the F1-terminating topology domain or includes the IP address information of the non-F1-terminating topology domain via the first indication information.

In some embodiments, the IP address configuration includes the IP address information of the non-F1-terminating topology domain.

In some embodiments, the first IAB-donor is a source donor for handover of the IAB node, and the second IAB-donor is a target donor for handover of the IAB node, and the first RRC reconfiguration message is a handover command RRC message.

The device further includes (not shown) a second receiving portion configured to receive the first RRC reconfiguration message transmitted by the second IAB-donor, and the first transmitting portion forwards the first RRC reconfiguration message generated by the second IAB-donor to the IAB node.

In some embodiments, the first IAB-donor is a master node MN of the IAB node, and the second IAB-donor is a secondary node SN of the IAB node.

For example, the first RRC reconfiguration message is an RRC reconfiguration message contained in a secondary cell group configuration field of the RRC reconfiguration message, and is carried by the second RRC reconfiguration message transmitted by the first IAB-donor;
and the first transmitting portion transmits the second RRC reconfiguration message to the IAB node via SRB1.

In some embodiments, the device further includes (not shown):
a third receiving portion configured to receive the first RRC reconfiguration message transmitted by the second IAB-donor.

In some embodiments, the device further includes (not shown):
a fourth receiving portion configured to receive the IP address configuration provided by the second IAB-donor; and
a second processing portion configured to generate the first RRC reconfiguration message instead of the second IAB-donor.

In some embodiments, the device further includes (not shown):
a fifth receiving portion configured to receive the IP address configuration provided by the second IAB-donor, and the first transmitting portion transmits the first RRC reconfiguration message via SRB1.

In some embodiments, the IAB-donor device indicates that the IP address configuration includes the IP address information of the non-F1-terminating topology domain by containing the first indication information in the first RRC reconfiguration message or the second RRC reconfiguration message.

In some embodiments, the IP address configuration includes the IP address information of the F1-terminating topology domain.

In some embodiments, the first IAB-donor is an SN of the IAB node, and the second IAB-donor is an MN of the IAB node.

For example, the first transmitting portion transmits the first RRC reconfiguration message to the IAB node via SRB3.

For example, the first transmitting portion transmits the first RRC reconfiguration message to the second IAB-donor, wherein the first RRC reconfiguration message is a secondary cell group configuration RRC message; or,
the first transmitting portion transmits the IP address configuration to the second IAB-donor.

In some embodiments, the first IAB-donor is a master node MN of the IAB node, and the second IAB-donor is a secondary node SN of the IAB node; and the first transmitting portion transmits the first RRC reconfiguration message to the IAB node via SRB1.

In some embodiments, the IAB-donor device indicates that the IP address configuration includes the IP address information of the F1-terminating topology domain by not containing the first indication information in the first RRC reconfiguration message.

In some embodiments, the first indication information is contained in a newly-added information element of the first RRC reconfiguration message or the second RRC reconfiguration message, or is contained in an IP address configuration list information element of the first RRC reconfiguration message or the second RRC reconfiguration message, or is contained in an IP address configuration information element of the first RRC reconfiguration message or the second RRC reconfiguration message, or is contained in an IP address index information element of the first RRC reconfiguration message or the second RRC reconfiguration message.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the IAB-donor device 1700 of the embodiments of this disclosure may further include other components or modules, and reference may be made to related techniques for particulars of these components or modules.

Furthermore, for the sake of simplicity, connection relationships between the components or modules or signal profiles thereof are only illustrated in FIG. 17. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

It can be seen from the above embodiments that the IP address of the non-F1-terminating topology domain or the IP address of the F1-terminating topology domain may be configured to the IAB node via the first RRC reconfiguration message. Hence, the boundary node may be enabled to respectively transmit traffics with routing IDs belonging to the F1-terminating topology domain and traffics with routing IDs belonging to the non-F1-terminating topology domain.

### Embodiments of a Sixth Aspect

The embodiments of this disclosure provide an IAB-donor device, with contents identical to those in the embodiments of the third aspect being not going to be described herein any further. The device may be, for example, an IAB-donor-CU (such as the second IAB-donor in the embodiments of the first, second and third aspects) in an IAB system, or may be one or more components or assemblies or modules configured in the IAB-donor-CU.

FIG. 18 is a schematic diagram of the IAB-donor device of the embodiments of this disclosure. As shown in FIG. 18, an IAB-donor device 1800 includes:
a second transmitting portion 1801 configured to transmit a first RRC reconfiguration message, the first RRC reconfiguration message including at least one IP address configuration for an IAB node, or transmit at least one IP address configuration for the IAB node,
the at least one IP address configuration including IP address information of an F1-terminating topology domain, or including IP address information of a non-F1-terminating topology domain.

F1 connection of the IAB node is terminated at the first IAB-donor, and the IAB node has RRC connection with a second IAB-donor.

In some embodiments, the IAB-donor device indicates via the first indication information that the IP address configuration includes IP address information of the F1-terminating topology domain, or includes IP address information of the non-F1-terminating topology domain.

In some embodiments, the IP address configuration includes IP address information of the non-F1-terminating topology domain.

In some embodiments, the first IAB-donor is a source donor for handover of the IAB node, the second IAB-donor is a target donor for handover of the IAB node, the first RRC reconfiguration message is a handover command RRC message, and the second transmitting portion transmits the first RRC reconfiguration message to the first IAB-donor.

In some embodiments, the first IAB-donor is a master node MN of the IAB node, and the second IAB-donor is a secondary node SN of the IAB node.

For example, the second transmitting portion transmits a first RRC reconfiguration message to the first IAB-donor, or transmits the IP address configuration to the first IAB-donor.

For example, the second transmitting portion transmits the first RRC reconfiguration message to the IAB node via SRB3.

In some embodiments, the first IAB-donor is an SN of the IAB node, the second IAB-donor is an MN of the IAB node, and the second transmitting portion transmits the first RRC reconfiguration message to the IAB node via SRB1.

In some embodiments, the IAB-donor device indicates that the IP address configuration includes the IP address information of the non-F1-terminating topology domain by containing the first indication information in the first RRC reconfiguration message.

In some embodiments, the IP address configuration includes the IP address information of the F1-terminating topology domain.

In some embodiments, the first IAB-donor is an SN of the IAB node, and the second IAB-donor is an MN of the IAB node.

For example, the first RRC reconfiguration message is an RRC reconfiguration message contained in a secondary cell group configuration field of the RRC reconfiguration message, and is carried by a third RRC reconfiguration message transmitted by the second IAB-donor; and the second transmitting portion transmits the third RRC reconfiguration message to the IAB node via SRB1.

In some embodiments, the device further includes (not shown):
a sixth receiving portion configured to receive the first RRC reconfiguration message transmitted by the first IAB-donor.

In some embodiments, the device further includes (not shown):
a seventh receiving portion configured to receive the IP address configuration provided by the first IAB-donor; and
a second processing portion configured to generate the first RRC reconfiguration message instead of the first IAB-donor.

In some embodiments, the device further includes (not shown):
an eighth receiving portion configured to receive the IP address configuration transmitted by the first IAB-donor, and the second transmitting portion transmits the first RRC reconfiguration message to the IAB node via SRB1.

In some embodiments, the IAB-donor device indicates that the IP address configuration includes the IP address information of the F1-terminating topology domain by not containing the first indication information in the first RRC reconfiguration message or the third RRC reconfiguration message.

In some embodiments, the first indication information is contained in a newly-added information element of the first RRC reconfiguration message or the second RRC reconfiguration message, or is contained in an IP address configuration list information element of the first RRC reconfiguration message or the second RRC reconfiguration message, or is contained in an IP address configuration information element of the first RRC reconfiguration message or the second RRC reconfiguration message, or is contained in an IP address index information element of the first RRC reconfiguration message or the second RRC reconfiguration message.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the IAB-donor device 1800 of the embodiments of this disclosure may further include other components or modules, and reference may be made to related techniques for particulars of these components or modules.

Furthermore, for the sake of simplicity, connection relationships between the components or modules or signal profiles thereof are only illustrated in FIG. 18. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

It can be seen from the above embodiments that the IP address of the non-F1-terminating topology domain or the IP address of the F1-terminating topology domain may be configured to the IAB node via the first RRC reconfiguration message. Hence, the boundary node may be enabled to respectively transmit traffics with routing IDs belonging to the F1-terminating topology domain and traffics with routing IDs belonging to the non-F1-terminating topology domain.

### Embodiments of a Seventh Aspect

The embodiments of this disclosure provide a communication system, including the first IAB-donor device in the embodiments of the fourth aspect, the second IAB-donor device in the embodiments of the second aspect and the IAB node device in the embodiments of the third aspect, and reference may be made to related techniques for network architectures of the donor devices and the IAB node device, which shall not be described herein any further.

The embodiments of this disclosure further provide an IAB device, which may be an IAB-donor device, or may be an IAB node device (a migrating node or a child node).

FIG. 9 is a schematic diagram of the IAB device of the embodiments of this disclosure. As shown in FIG. 9, an IAB device 900 may include a processor (such as a central processing unit (CPU)) 901 and a memory 902, the memory 902 being coupled to the processor 901. The memory 902 may store various data, and furthermore, it may store a program 905 for information processing, and execute the program 950 under control of the processor 901.

For example, the processor 901 may be configured to execute a program to carry out a transport address determination method in the embodiments of the first aspect.

For another example, the processor 901 may be configured to execute a program to carry out a transport address determination method in the embodiments of the second aspect.

For a further example, the processor 901 may be configured to execute a program to carry out a transport address determination method in the embodiments of the third aspect.

Furthermore, as shown in FIG. 9, the IAB device 900 may include a transceiver 903, and an antenna 904, etc. Functions of the above components are similar to those in the related art, and shall not be described herein any further. It should be noted that the IAB device 900 does not necessarily include all the parts shown in FIG. 9, and furthermore, the IAB device 900 may include parts not shown in FIG. 9, and the related art may be referred to.

Embodiments of this disclosure provide a computer readable program, which, when executed in an IAB device, causes a computer to carry out a transport address determination method as described in the embodiments of the first to the third aspects in the IAB device.

Embodiments of this disclosure provide a computer storage medium, including a computer readable program, which causes a computer to carry out a transport address determination method as described in the embodiments of the first to the third aspects in an IAB device.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, an EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of this disclosure. Various variants and modifications may be made by those skilled in the art according to the spirits and principle of this disclosure, and such variants and modifications fall within the scope of this disclosure.

As to implementations containing the above embodiments, following supplements are further disclosed.

### At a Boundary Node Side

1. A transport address determination method, applicable to an IAB node device, characterized in that the method includes:
receiving a first RRC reconfiguration message by an IAB node, the first RRC reconfiguration message including at least one IP address configuration for the IAB node,
the at least one IP address configuration containing IP address information of an F1-terminating topology domain, or containing IP address information of a non-F1-terminating topology domain.
2. The method according to supplement 1, wherein F1 connection of the IAB node is terminated at a first IAB-donor, and the IAB node has RRC connection with a second IAB-donor.
3. The method according to supplement 2, wherein the method further includes:
determining by the IAB node that the IP address configuration includes IP address information of an F1-terminating topology domain or IP address information of a non-F1-terminating topology domain.
4. The method according to supplement 3, wherein the IAB node determines according to first indication information that the IP address configuration includes the IP address information of the F1-terminating topology domain or the IP address information of the non-F1-terminating topology domain.
5. The method according to supplement 3 or 4, wherein the IAB node determines that the IP address configuration includes IP address information of the non-F1-terminating topology domain.
6. The method according to supplement 5, wherein the first IAB-donor is a source donor for handover of the IAB node, and the second IAB-donor is a target donor for handover of the IAB node;
and the first RRC reconfiguration message is a handover command RRC message generated by the second IAB-donor and forwarded by the first IAB-donor.
7. The method according to supplement 5, wherein the first IAB-donor is a master node MN of the IAB node, and the second IAB-donor is a secondary node SN of the IAB node.
8. The method according to supplement 7, wherein the first RRC reconfiguration message is an RRC reconfiguration message contained in a secondary cell group configuration field in the RRC reconfiguration message, and is carried by a second RRC reconfiguration message transmitted by the first IAB-donor;
and the IAB node receives, via SRB1, the second RRC reconfiguration message transmitted by the first IAB-donor.
9. The method according to supplement 8, wherein the first RRC reconfiguration message is generated by the first IAB-donor instead of the second IAB-donor.
10. The method according to supplement 7, wherein the IAB node receives via SRB3 the first RRC reconfiguration message transmitted by the second IAB-donor.
11. The method according to supplement 7, wherein the IAB node receives via SRB1 the first RRC reconfiguration message transmitted by the first IAB-donor.
12. The method according to supplement 5, wherein the first IAB-donor is the SN of the IAB node, and the second IAB-donor is the MN of the IAB node;
and the IAB node receives, via SRB1, the first RRC reconfiguration message transmitted by the second IAB-donor.
13. The method according to any one of supplements 5-12, wherein the IAB node determines that the IP address configuration contains the IP address information of the non-F1-terminating topology domain when the first RRC reconfiguration message or the second RRC reconfiguration message contains the first indication information.
14. The method according to supplement 3 or 4, wherein the IAB node determines that the IP address configuration includes IP address information of an F1-terminating topology domain.
15. The method according to supplement 14, wherein the first IAB-donor is a master node MN of the IAB node, and the second IAB-donor is a secondary node SN of the IAB node;
and the IAB node receives via SRB1 the first RRC reconfiguration message transmitted by the first IAB-donor.
16. The method according to supplement 11, wherein the first IAB-donor is an SN of the IAB node, and the second IAB-donor is an MN of the IAB node.
17. The method according to supplement 16, wherein the first RRC reconfiguration message is an RRC reconfiguration message contained in a secondary cell configuration domain in the RRC reconfiguration message, and is carried by a third RRC reconfiguration message transmitted by the second IAB-donor;
and the IAB node receives, via SRB1, the third RRC reconfiguration message transmitted by the second IAB-donor.
18. The method according to supplement 17, wherein the first RRC reconfiguration message is generated by the second IAB-donor instead of the first IAB-donor.
19. The method according to supplement 16, wherein the IAB node receives via SRB3 the first RRC reconfiguration message transmitted by the first IAB-donor.
20. The method according to supplement 16, wherein the IAB node receives via SRB1 the first RRC reconfiguration message transmitted by the second IAB-donor.
21. The method according to any one of supplements 14-20, wherein the IAB node determines that the IP address configuration contains IP address information of the F1-terminating topology domain when the first RRC reconfiguration message or the third RRC reconfiguration message does not contain the first indication information.
22. The method according to supplement 13, wherein the first indication information is contained in a newly-added information element of the first RRC reconfiguration message or the second RRC reconfiguration message, or is contained in an IP address configuration list information element of the first RRC reconfiguration message or the second RRC reconfiguration message, or is contained in an IP address configuration information element of the first RRC reconfiguration message or the second RRC reconfiguration message, or is contained in an IP address index information element of the first RRC reconfiguration message or the second RRC reconfiguration message.
23. An IAB-donor device, including a memory and a processor, the memory storing a computer program, and the processor being configured to execute the computer program to carry out a transport address determination method as described in any one of supplements 1-22.

### At a First Donor-CU Node Side

1. A transport address determination method, applicable to a first IAB-donor, characterized in that the method includes:
transmitting a first RRC reconfiguration message by the first IAB-donor, the first RRC reconfiguration message including at least one IP address configuration for an IAB node, or,
transmitting at least one IP address configuration of the IAB node, the at least one IP address configuration including IP address information of an F1-terminating topology domain, or including IP address information of a non-F1-terminating topology domain;
wherein F1 connection of the IAB node is terminated at the first IAB-donor, and the IAB node has RRC connection with a second IAB-donor.
2. The method according to supplement 1, wherein the first IAB-donor indicates via the first indication information that the IP address configuration includes the IP address information of the F1-terminating topology domain or includes the IP address information of the non-F1-terminating topology domain.
3. The method according to supplement 1 or 2, wherein the IP address configuration includes the IP address information of the non-F1-terminating topology domain.
4. The method according to supplement 3, wherein the first IAB-donor is a source donor for handover of the IAB node, the second IAB-donor is a target donor for handover of the IAB node, and the first RRC reconfiguration message is a handover command RRC message,
wherein the first IAB-donor receives a first RRC reconfiguration message transmitted by the second IAB-donor, and forwards the first RRC reconfiguration message generated by the second IAB-donor to the IAB node.
5. The method according to supplement 3, wherein the first IAB-donor is a master node MN of the IAB node, and the second IAB-donor is a secondary node SN of the IAB node.
6. The method according to supplement 5, wherein the first RRC reconfiguration message is an RRC reconfiguration message contained in a secondary cell group configuration field of the RRC reconfiguration message and carried by a second RRC reconfiguration message transmitted by the first IAB-donor;
and the first IAB-donor transmits the second RRC reconfiguration message to the IAB node via SRB1.
7. The method according to supplement 6, wherein the method further includes:
receiving, by the first IAB-donor, the first RRC reconfiguration message transmitted by the second IAB-donor.
8. The method according to supplement 6, wherein the method further includes:
receiving the IP address configuration provided by the second IAB-donor and generating the first RRC reconfiguration message instead of the second IAB-donor by the first IAB-donor.
9. The method according to supplement 5, wherein the method further includes:
receiving the IP address configuration provided by the second IAB-donor and transmitting the first RRC reconfiguration message via SRB1 by the first IAB-donor.
10. The method according to any one of supplements 3-9, wherein the first IAB-donor indicates that the IP address configuration includes the IP address information of the non-F1-terminating topology domain by containing the first indication information in the first RRC reconfiguration message or the second RRC reconfiguration message.
11. The method according to supplement 1 or 2, wherein the IP address configuration includes the IP address information of the F1-terminating topology domain.
12. The method according to supplement 11, wherein the first IAB-donor is an SN of the IAB node, and the second IAB-donor is an MN of the IAB node.
13. The method according to supplement 12, wherein,
the first IAB-donor transmits the first RRC reconfiguration message to the IAB node via SRB3.
14. The method according to supplement 12, wherein the first IAB-donor transmits the first RRC reconfiguration message to the second IAB-donor, wherein the first RRC reconfiguration message is a secondary cell group configuration RRC message; or
the first IAB-donor transmits the IP address configuration to the second IAB-donor.
15. The method according to supplement 11, wherein the first IAB-donor is a master node MN of the IAB node, and the second IAB-donor is a secondary node SN of the IAB node;
and the first IAB-donor transmits the first RRC reconfiguration message to the IAB node via SRB1.
17. The method according to any one of supplements 11-15, wherein the first IAB-donor indicates that the IP address configuration contains the IP address information of the F1-terminating topology domain by not containing the first indication information in the first RRC reconfiguration message.
18. The method according to supplement 10, wherein the first indication information is included in a newly-added information element of the first RRC reconfiguration message or the second RRC reconfiguration message, or in an IP address configuration list information element of the first RRC reconfiguration message or the second RRC reconfiguration message, or in an IP address configuration information element of the first RRC reconfiguration message or the second RRC reconfiguration message, or in an IP address index information element of the first RRC reconfiguration message or the second RRC reconfiguration message.
19. An IAB-donor device, including a memory and a processor, the memory storing a computer program, and the processor being configured to execute the computer program to carry out a transport address determination method as described in any one of supplements 1-17.

### At a Second Donor-CU Node Side

1. A transport address determination method, applicable to a second IAB-donor, characterized in that the method includes:
transmitting a first RRC reconfiguration message by the second IAB-donor, the first RRC reconfiguration message including at least one IP address configuration for an IAB node, or transmitting at least one IP address configuration for the IAB node,
the at least one IP address configuration including IP address information of an F1-terminating topology domain, or including IP address information of a non-F1-terminating topology domain,
wherein F1 connection of the IAB node is terminated at a first IAB-donor, and the IAB node has RRC connection with a second IAB-donor.
2. The method according to supplement 1, wherein the second IAB-donor indicates via the first indication information that the IP address configuration includes the IP address information of the F1-terminating topology domain or includes the IP address information of the non-F1-terminating topology domain.
3. The method according to supplement 1 or 2, wherein the IP address configuration includes the IP address information of the non-F1-terminating topology domain.
4. The method according to supplement 3, wherein the first IAB-donor is a source donor for handover of the IAB node, the second IAB-donor is a target donor for handover of the IAB node, and the first RRC reconfiguration message is a handover command RRC message,
and the second IAB-donor transmits the first RRC reconfiguration message to the first IAB-donor.
5. The method according to supplement 3, wherein the first IAB-donor is a master node MN of the IAB node, and the second IAB-donor is a secondary node SN of the IAB node.
6. The method according to supplement 5, wherein the second IAB-donor transmits the first RRC reconfiguration message to the first IAB node,
or transmits the IP address configuration to the first IAB-donor.
7. The method according to supplement 5, wherein the second IAB-donor transmits the first RRC configuration message to the IAB-donor via SRB3.
8. The method according to supplement 3, wherein the first IAB-donor is an SN of the IAB node, and the second IAB-donor is an MN of the IAB node,
and the second IAB-donor transmits the first RRC reconfiguration message to the IAB node via SRB1.
9. The method according to any one of supplements 3-8, wherein the second IAB-donor indicates that the IP address configuration includes the IP address information of the non-F1-terminating topology domain by containing the first indication information in the first RRC reconfiguration message.
10. The method according to supplement 1 or 2, wherein the IP address configuration includes the IP address information of the F1-terminating topology domain.
11. The method according to supplement 10, wherein the first IAB-donor is an SN of the IAB node, and the second IAB-donor is an MN of the IAB node.
12. The method according to supplement 11, wherein the first RRC reconfiguration message is an RRC reconfiguration message contained in a secondary cell group configuration field in the RRC reconfiguration message and carried by a third RRC reconfiguration message transmitted by the second IAB-donor;
and the second IAB-donor transmits the third RRC reconfiguration message to the IAB node via SRB1.
13. The method according to supplement 12, wherein the method further includes:
receiving, by the second IAB-donor, the first RRC reconfiguration message transmitted by the first IAB-donor.
14. The method according to supplement 12, wherein the second IAB-donor receives the IP address configuration provided by the first IAB-donor, and generates the first RRC reconfiguration message instead of the first IAB-donor.
15. The method according to supplement 11, wherein the method further includes:
receiving, by the second IAB-donor, the IP address configuration transmitted by the first IAB-donor, and transmitting the first RRC reconfiguration message to the IAB node via SRB1.
16. The method according to any one of supplements 11-15, wherein the second IAB-donor indicates that the IP address configuration includes the IP address information of the F1-terminating topology domain by not containing the first indication information in the first RRC reconfiguration message or the third RRC reconfiguration message.
17. The method according to supplement 9, wherein the first indication information is contained in a newly-added information element of the first RRC reconfiguration message or the second RRC reconfiguration message, or contained in an IP address configuration list information element of the first RRC reconfiguration message or the second RRC reconfiguration message, or contained in an IP address configuration information element of the first RRC reconfiguration message or the second RRC reconfiguration message, or contained in an IP address index information element of the first RRC reconfiguration message or the second RRC reconfiguration message.
18. An IAB-donor device, including a memory and a processor, the memory storing a computer program, and the processor being configured to execute the computer program to carry out a transport address determination method as described in any one of supplements 1-17.

### At a Boundary Node Side

1. An IAB node device, characterized in that the device includes:
a first receiving portion configured to receive a first RRC reconfiguration message, the first RRC reconfiguration message including at least one IP address configuration for the IAB node,
the at least one IP address configuration containing IP address information of an F1-terminating topology domain, or containing IP address information of a non-F1-terminating topology domain.
2. The device according to supplement 1, wherein F1 connection of the IAB node is terminated at a first IAB-donor, and the IAB node has RRC connection with a second IAB-donor.
3. The device according to supplement 2, wherein the device further includes:
a first processing portion configured to determine that the IP address configuration includes IP address information of an F1-terminating topology domain or IP address information of a non-F1-terminating topology domain.
4. The device according to supplement 3, wherein the first processing portion determines according to first indication information that the IP address configuration includes the IP address information of the F1-terminating topology domain or the IP address information of the non-F1-terminating topology domain.
5. The device according to supplement 3 or 4, wherein the first processing portion determines that the IP address configuration includes IP address information of the non-F1-terminating topology domain.
6. The device according to supplement 5, wherein the first IAB-donor is a source donor for handover of the IAB node, and the second IAB-donor is a target donor for handover of the IAB node;
and the first RRC reconfiguration message is a handover command RRC message generated by the second IAB-donor and forwarded by the first IAB-donor.
7. The device according to supplement 5, wherein the first IAB-donor is a master node MN of the IAB node, and the second IAB-donor is a secondary node SN of the IAB node.
8. The device according to supplement 7, wherein the first RRC reconfiguration message is an RRC reconfiguration message contained in a secondary cell group configuration field in the RRC reconfiguration message, and is carried by a second RRC reconfiguration message transmitted by the first IAB-donor;
and the first receiving portion receives, via SRB1, the second RRC reconfiguration message transmitted by the first IAB-donor.
9. The device according to supplement 8, wherein the first RRC reconfiguration message is generated by the first IAB-donor instead of the second IAB-donor.
10. The device according to supplement 7, wherein the first receiving portion receives via SRB3 the first RRC reconfiguration message transmitted by the second IAB-donor.
11. The device according to supplement 7, wherein the first receiving portion receives via SRB1 the first RRC reconfiguration message transmitted by the first IAB-donor.
12. The device according to supplement 5, wherein the first IAB-donor is the SN of the IAB node, and the second IAB-donor is the MN of the IAB node;
and the first receiving portion receives, via SRB1, the first RRC reconfiguration message transmitted by the second IAB-donor.
13. The device according to any one of supplements 5-12, wherein the first processing portion determines that the IP address configuration contains the IP address information of the non-F1-terminating topology domain when the first RRC reconfiguration message or the second RRC reconfiguration message contains the first indication information.
14. The device according to supplement 3 or 4, wherein the first processing portion determines that the IP address configuration includes IP address information of an F1-terminating topology domain.
15. The device according to supplement 14, wherein the first IAB-donor is a master node MN of the IAB node, and the second IAB-donor is a secondary node SN of the IAB node;
and the first receiving portion receives via SRB1 the first RRC reconfiguration message transmitted by the first IAB-donor.
16. The device according to supplement 11, wherein the first IAB-donor is an SN of the IAB node, and the second IAB-donor is an MN of the IAB node.
17. The device according to supplement 16, wherein the first RRC reconfiguration message is an RRC reconfiguration message contained in a secondary cell configuration domain in the RRC reconfiguration message, and is carried by a third RRC reconfiguration message transmitted by the second IAB-donor;
and the first receiving portion receives, via SRB1, the third RRC reconfiguration message transmitted by the second IAB-donor.
18. The device according to supplement 17, wherein the first RRC reconfiguration message is generated by the second IAB-donor instead of the first IAB-donor.
19. The device according to supplement 16, wherein the first receiving portion receives via SRB3 the first RRC reconfiguration message transmitted by the first IAB-donor.
20. The device according to supplement 16, wherein the first receiving portion receives via SRB1 the first RRC reconfiguration message transmitted by the second IAB-donor.
21. The device according to any one of supplements 14-20, wherein the first processing portion determines that the IP address configuration contains IP address information of the F1-terminating topology domain when the first RRC reconfiguration message or the third RRC reconfiguration message does not contain the first indication information.
22. The device according to supplement 13, wherein the first indication information is contained in a newly-added information element of the first RRC reconfiguration message or the second RRC reconfiguration message, or is contained in an IP address configuration list information element of the first RRC reconfiguration message or the second RRC reconfiguration message, or is contained in an IP address configuration information element of the first RRC reconfiguration message or the second RRC reconfiguration message, or is contained in an IP address index information element of the first RRC reconfiguration message or the second RRC reconfiguration message.

### At a First Donor-CU Node Side

1. An IAB-donor device, applicable to a first IAB-donor, characterized in that the device includes:
a first transmitting portion configured to transmit a first RRC reconfiguration message, the first RRC reconfiguration message including at least one IP address configuration for an IAB node, or, transmit at least one IP address configuration of the IAB node,
the at least one IP address configuration including IP address information of an F1-terminating topology domain, or including IP address information of a non-F1-terminating topology domain;
wherein F1 connection of the IAB node is terminated at the first IAB-donor, and the IAB node has RRC connection with a second IAB-donor.
2. The device according to supplement 1, wherein the first IAB-donor indicates via the first indication information that the IP address configuration includes the IP address information of the F1-terminating topology domain or includes the IP address information of the non-F1-terminating topology domain.
3. The device according to supplement 1 or 2, wherein the IP address configuration includes the IP address information of the non-F1-terminating topology domain.
4. The device according to supplement 3, wherein the first IAB-donor is a source donor for handover of the IAB node, the second IAB-donor is a target donor for handover of the IAB node, and the first RRC reconfiguration message is a handover command RRC message;
wherein the device further includes: a second receiving portion configured to receive a first RRC reconfiguration message transmitted by the second IAB-donor, and the first transmitting portion forwards the first RRC reconfiguration message generated by the second IAB-donor to the IAB node.
5. The device according to supplement 3, wherein the first IAB-donor is a master node MN of the IAB node, and the second IAB-donor is a secondary node SN of the IAB node.
6. The device according to supplement 5, wherein the first RRC reconfiguration message is an RRC reconfiguration message contained in a secondary cell group configuration field of the RRC reconfiguration message and carried by a second RRC reconfiguration message transmitted by the first IAB-donor;
and the first transmitting portion transmits the second RRC reconfiguration message to the IAB node via SRB1.
7. The device according to supplement 6, wherein the device further includes:
a third receiving portion configured to receive the first RRC reconfiguration message transmitted by the second IAB-donor.
8. The device according to supplement 6, wherein the device further includes:
a fourth receiving portion configured to receive the IP address configuration provided by the second IAB-donor; and
a second processing portion configured to generate the first RRC reconfiguration message instead of the second IAB-donor.
9. The device according to supplement 5, wherein the device further includes:
a fifth receiving portion configured to receive the IP address configuration provided by the second IAB-donor, and the first transmitting portion transmits the first RRC reconfiguration message via SRB1.
10. The device according to any one of supplements 3-9, wherein the first IAB-donor indicates that the IP address configuration includes the IP address information of the non-F1-terminating topology domain by containing the first indication information in the first RRC reconfiguration message or the second RRC reconfiguration message.
11. The device according to supplement 1 or 2, wherein the IP address configuration includes the IP address information of the F1-terminating topology domain.
12. The device according to supplement 11, wherein the first IAB-donor is an SN of the IAB node, and the second IAB-donor is an MN of the IAB node.
13. The device according to supplement 12, wherein, the first transmitting portion transmits the first RRC reconfiguration message to the IAB node via SRB3.
14. The device according to supplement 12, wherein the first transmitting portion transmits the first RRC reconfiguration message to the second IAB-donor, wherein the first RRC reconfiguration message is a secondary cell group configuration RRC message; or
the first transmitting portion transmits the IP address configuration to the second IAB-donor.
15. The device according to supplement 11, wherein the first IAB-donor is a master node MN of the IAB node, and the second IAB-donor is a secondary node SN of the IAB node;
and the first transmitting portion transmits the first RRC reconfiguration message to the IAB node via SRB1.
17. The device according to any one of supplements 11-15, wherein the first IAB-donor indicates that the IP address configuration contains the IP address information of the F1-terminating topology domain by not containing the first indication information in the first RRC reconfiguration message.
18. The device according to supplement 10, wherein the first indication information is included in a newly-added information element of the first RRC reconfiguration message or the second RRC reconfiguration message, or in an IP address configuration list information element of the first RRC reconfiguration message or the second RRC reconfiguration message, or in an IP address configuration information element of the first RRC reconfiguration message or the second RRC reconfiguration message, or in an IP address index information element of the first RRC reconfiguration message or the second RRC reconfiguration message.

### At a Second Donor-CU Node Side

1. An IAB-donor device, applicable to a second IAB-donor, characterized in that the device includes:
a second transmitting portion configured to transmit a first RRC reconfiguration message, the first RRC reconfiguration message including at least one IP address configuration for an IAB node, or transmit at least one IP address configuration for the IAB node,
the at least one IP address configuration including IP address information of an F1-terminating topology domain, or including IP address information of a non-F1-terminating topology domain;
wherein F1 connection of the IAB node is terminated at a first IAB-donor, and the IAB node has RRC connection with a second IAB-donor.
2. The device according to supplement 1, wherein the IAB-donor device indicates via the first indication information that the IP address configuration includes the IP address information of the F1-terminating topology domain or includes the IP address information of the non-F1-terminating topology domain.
3. The device according to supplement 1 or 2, wherein the IP address configuration includes the IP address information of the non-F1-terminating topology domain.
4. The device according to supplement 3, wherein the first IAB-donor is a source donor for handover of the IAB node, the second IAB-donor is a target donor for handover of the IAB node, and the first RRC reconfiguration message is a handover command RRC message,
and the second transmitting portion transmits the first RRC reconfiguration message to the first IAB-donor.
5. The device according to supplement 3, wherein the first IAB-donor is a master node MN of the IAB node, and the second IAB-donor is a secondary node SN of the IAB node.
6. The device according to supplement 5, wherein the second transmitting portion transmits the first RRC reconfiguration message to the first IAB node,
or transmits the IP address configuration to the first IAB-donor.
7. The device according to supplement 5, wherein the second transmitting portion transmits the first RRC configuration message to the IAB-donor via SRB3.
8. The device according to supplement 3, wherein the first IAB-donor is an SN of the IAB node, and the second IAB-donor is an MN of the IAB node,
and the second transmitting portion transmits the first RRC reconfiguration message to the IAB node via SRB1.
9. The device according to any one of supplements 3-8, wherein the IAB-donor device indicates that the IP address configuration includes the IP address information of the non-F1-terminating topology domain by containing the first indication information in the first RRC reconfiguration message.
10. The device according to supplement 1 or 2, wherein the IP address configuration includes the IP address information of the F1-terminating topology domain.
11. The device according to supplement 10, wherein the first IAB-donor is an SN of the IAB node, and the second IAB-donor is an MN of the IAB node.
12. The device according to supplement 11, wherein the first RRC reconfiguration message is an RRC reconfiguration message contained in a secondary cell group configuration field in the RRC reconfiguration message and carried by a third RRC reconfiguration message transmitted by the second IAB-donor;
and the second transmitting portion transmits the third RRC reconfiguration message to the IAB node via SRB1.
13. The device according to supplement 12, wherein the device further includes:
a sixth receiving portion configured to receive the first RRC reconfiguration message transmitted by the first IAB-donor.
14. The device according to supplement 12, wherein the device further includes:
a seventh receiving portion configured to receive the IP address configuration provided by the first IAB-donor; and
a third processing portion configured to generate the first RRC reconfiguration message instead of the first IAB-donor.
15. The device according to supplement 11, wherein the device further includes:
an eighth receiving portion configured to receive the IP address configuration transmitted by the first IAB-donor, and the second transmitting portion transmits the first RRC reconfiguration message to the IAB node via SRB1.
16. The device according to any one of supplements 11-15, wherein the IAB-donor device indicates that the IP address configuration includes the IP address information of the F1-terminating topology domain by not containing the first indication information in the first RRC reconfiguration message or the third RRC reconfiguration message.
17. The device according to supplement 9, wherein the first indication information is contained in a newly-added information element of the first RRC reconfiguration message or the second RRC reconfiguration message, or contained in an IP address configuration list information element of the first RRC reconfiguration message or the second RRC reconfiguration message, or contained in an IP address configuration information element of the first RRC reconfiguration message or the second RRC reconfiguration message, or contained in an IP address index information element of the first RRC reconfiguration message or the second RRC reconfiguration message.

1. An integrated access and backhaul IAB node comprising:
a receiver configured to receive a first RRC (Radio Resource Control) reconfiguration message, the first RRC reconfiguration message including IP address information for the IAB node of an F1-terminating topology domain which includes a TNL (transport network layer) address anchored at a donor-DU under an F1-terminating donor-CU for the IAB node, or IP address information for the IAB node of a non-F1-terminating topology domain which includes a TNL address anchored at a donor-DU under a non-F1-terminating donor-CU for the IAB node.

2. The IAB node according to claim 1, wherein F1 connection of the IAB node is terminated at a first IAB-donor-CU, and the IAB node has RRC connection with a second IAB-donor-CU.

3. The IAB node according to claim 2, further comprising:
processor circuitry configured to determine that the first RRC reconfiguration message comprises the IP address information of the F1-terminating topology domain or the IP address information of the non-F1-terminating topology domain.

4. The IAB node according to claim 2, wherein the first IAB-donor-CU is a master node (MN) of the IAB node, and the second IAB-donor-CU is a secondary node (SN) of the IAB node.

5. The IAB node according to claim 4, wherein the first RRC reconfiguration message is an RRC reconfiguration message contained in a secondary cell group configuration field in the RRC reconfiguration message, and is carried by a second RRC reconfiguration message;
and the receiver receives, via SRB1, the second RRC reconfiguration message.

6. The IAB node according to claim 4, wherein the receiver receives, via SRB3, the first RRC reconfiguration message transmitted by the second IAB-donor-CU.

7. The IAB node according to claim 2, wherein the first IAB-donor-CU is the SN of the IAB node, and the second IAB-donor-CU is the MN of the IAB node;
and the first receiver receives, via SRB1, the first RRC reconfiguration message transmitted by the second IAB-donor-CU.

8. The IAB node according to claim 2, wherein the first IAB-donor-CU is a source donor-CU from which the IAB node is handed over, and the second IAB-donor-CU is a target donor-CU to which the IAB node is handed over;
and the first RRC reconfiguration message is a handover command RRC message generated by the second IAB-donor-CU forwarded by the first IAB-donor-CU.

9. An integrated access and backhaul (IAB) donor device, applicable to a first IAB-donor-CU, the IAB donor device comprising:
a transmitter configured to transmit a first RRC (Radio Resource Control) reconfiguration message, the first RRC reconfiguration message including IP address information for an IAB node of an F1-terminating topology domain which includes a TNL (transport network layer) address anchored at a donor-DU under an F1-terminating donor-CU for the IAB node, or IP address information for an IAB node of a non-F1-terminating topology domain which includes a TNL address anchored at a donor-DU under a non-F1-terminating donor-CU for the IAB node;
wherein F1 connection of the IAB node is terminated at the first IAB-donor-CU.

10. The IAB donor device according to claim 9, wherein the first IAB-donor-CU is a master node (MN) of the IAB node, and the IAB node has RRC connection with a second IAB-donor-CU and the second IAB-donor-CU is a secondary node (SN) of the IAB node.

11. The IAB donor device according to claim 10, wherein
the first RRC reconfiguration message is an RRC reconfiguration message contained in a secondary cell group configuration field in the RRC reconfiguration message, and is carried by a second RRC reconfiguration message transmitted by the first IAB-donor-CU, and
the transmitter transmits, via SRB1, the second RRC reconfiguration message.

12. The IAB donor device according to claim 9, wherein the first IAB-donor-CU is a source donor-CU from which the IAB node is handed over, and the IAB node has RRC connection with a second IAB-donor-CU, the second IAB-donor-CU is a target donor-CU to which the IAB node is handed over;
and the first RRC reconfiguration message is a handover command RRC message generated by the second IAB-donor-CU forwarded by the first IAB-donor-CU.

13. An integrated access and backhaul (IAB) donor device, applicable to a second IAB-donor-CU, the device comprising:
a transmitter configured to transmit a first RRC (Radio Resource Control) reconfiguration message, the first RRC reconfiguration message including IP address information for an IAB node of an F1-terminating topology domain, or IP address information for an IAB node of a non-F1-terminating topology domain;
wherein IP address information for the IAB node of a F1-terminating topology domain includes a TNL address anchored at a donor-DU under an F1-terminating donor-CU for the IAB node, IP address information for the IAB node of a non-F1-terminating topology domain includes a TNL address anchored at a donor-DU under a non-F1-terminating donor-CU for the IAB node;
wherein F1 connection of the IAB node is terminated at a first IAB-donor-CU.

14. The device according to claim 13, wherein the first IAB-donor-CU is the SN of the IAB node, and the IAB node has RRC connection with the second IAB-donor-CU and the second IAB-donor-CU is the MN of the LAB node;
and transmitter transmits, via SRB1, the first RRC reconfiguration message.

15. The LAB donor device according to claim 13, wherein
the first LAB-donor-CU is the MN of the LAB node, and the LAB node has RRC connection with the second LAB-donor-CU and the second LAB-donor-CU is the SN of the LAB node, and
transmitter transmits, via SRB3, the first RRC reconfiguration message.
